(19) United States
(12) Patent Application Publication
(10) Pub. No.: US 2025/0016062 A1
(43) Pub. Date: Jan. 9, 2025

(54) WIRELESS COMMUNICATION METHOD, TERMINAL DEVICE, AND CORE NETWORK ELEMENT

(71) Applicant: GUANGDONG OPPO MOBILE TELECOMMUNICATIONS CORP., LTD., Dongguan (CN)

(72) Inventors: Yang XU, Dongguan (CN); Jingran CHEN, Dongguan (CN); Boren GUO, Dongguan (CN)

(21) Appl. No.: 18/892,148

(22) Filed: Sep. 20, 2024

Related U.S. Application Data
(63) Continuation of application No. PCT/CN2022/083794, filed on Mar. 29, 2022.

(51) Int. Cl. H04L 41/14; H04L 43/02

(52) U.S. Cl. CPC H04L 41/14; H04L 43/02

(57) ABSTRACT

Disclosed are a wireless communication method, a terminal device, and a core network element. The method includes: transmitting, by a terminal device, a first request, where the first request is used to request first information; and receiving, by the terminal device, the first information transmitted by a first core network element, where the first information includes an analysis result of a first network data analysis service or a monitoring result of a first event. The first core network element may provide the terminal device with the analysis result of the network data analysis service or the monitoring result of the first event.

### CROSS-REFERENCE TO RELATED APPLICATIONS

This application is a continuation of International Application No. PCT/CN2022/083794, filed on Mar. 29, 2022, the disclosure of which is hereby incorporated by reference in its entirety.

### TECHNICAL FIELD

This application relates to the field of communication technologies, and more specifically, to a wireless communication method, a terminal device, and a core network element.

### BACKGROUND

Currently, a first core network element provides an operator with only a network data analysis service or a monitoring result of an event, resulting in a relatively limited application range of the first core network element.

### SUMMARY

This application provides a wireless communication method, a terminal device, and a core network element, which help expand an application range of a first core network element.

According to a first aspect, a wireless communication method is provided, and includes: transmitting, by a terminal device, a first request, where the first request is used to request first information; and receiving, by the terminal device, the first information transmitted by a first core network element, where the first information includes an analysis result of a first network data analysis service or a monitoring result of a first event.

According to a second aspect, a wireless communication method is provided, and includes: receiving, by a first core network element, a second request, where the second request is used by a terminal device to request first information; and transmitting, by the first core network element, the first information to the terminal device, where the first information includes an analysis result of a first network data analysis service or a monitoring result of a first event.

According to a third aspect, a wireless communication method is provided, and includes: transmitting, by a first data collection application function (DCAF), a second request to a first core network element, where the second request is used by a terminal device to request first information; receiving, by the first DCAF, the first information transmitted by the first core network element; and transmitting, by the first DCAF, the first information to the terminal device, where the first information includes an analysis result of a first network data analysis service or a monitoring result of a first event.

According to a fourth aspect, a wireless communication method is provided, and includes: transmitting, by an application function (AF), a third request, where the third request is used to request a candidate terminal device; and receiving, by the AF, first indication information transmitted by a second core network element, where the first indication information is used to indicate the candidate terminal device.

According to a fifth aspect, a wireless communication method is provided, and includes: receiving, by a second core network element, a third request, where the third request is used by an application function (AF) to request a candidate terminal device; and transmitting, by the second core network element, first indication information to the AF, where the first indication information is used to indicate the candidate terminal device.

According to a sixth aspect, a wireless communication method is provided, and includes: transmitting, by a terminal device, first capability information to a third core network element, where the first capability information is used to indicate whether the terminal device supports communication with the third core network element by using a third data collection application function (DCAF); and/or, receiving, by the terminal device, second capability information transmitted by the third core network element, where the second capability information indicates whether the terminal device is allowed to communicate with the third core network element by using the third DCAF.

According to a seventh aspect, a wireless communication method is provided, and includes: receiving, by a third core network element, first capability information transmitted by a terminal device, where the first capability information is used to indicate whether the terminal device supports communication with the third core network element by using a third DCAF; and/or, transmitting, by the third core network element, second capability information to the terminal device, where the second capability information indicates whether the terminal device is allowed to communicate with the third core network element by using the third DCAF.

According to an eighth aspect, a terminal device is provided, and includes: a transmitting unit, configured to transmit a first request, where the first request is used to request first information; and a receiving unit, configured to receive the first information transmitted by a first core network element, where the first information includes an analysis result of a first network data analysis service or a monitoring result of a first event.

According to a ninth aspect, a first core network element is provided, and includes: a receiving unit, configured to receive a second request, where the second request is used by a terminal device to request first information; and a transmitting unit, configured to transmit the first information to the terminal device, where the first information includes an analysis result of a first network data analysis service or a monitoring result of a first event.

According to a tenth aspect, a first data collection application function (DCAF) is provided, and includes: a transmitting unit, configured to transmit a second request to a first core network element, where the second request is used by a terminal device to request first information; and a receiving unit, configured to receive the first information transmitted by the first core network element. The transmitting unit is configured to transmit the first information to the terminal device, where the first information includes an analysis result of a first network data analysis service or a monitoring result of a first event.

According to an eleventh aspect, an application function (AF) is provided, and includes: a transmitting unit, configured to transmit a third request, where the third request is used to request a candidate terminal device; and a receiving unit, configured to receive first indication information transmitted by a second core network element, where the first indication information is used to indicate the candidate terminal device.

According to a twelfth aspect, a second core network element is provided, and includes: a receiving unit, configured to receive a third request, where the third request is used by an application function (AF) to request a candidate terminal device; and a transmitting unit, configured to transmit first indication information to the AF, where the first indication information is used to indicate the candidate terminal device.

According to a thirteenth aspect, a terminal device is provided, and includes: a transmitting unit, configured to transmit first capability information to a third core network element, where the first capability information is used to indicate whether the terminal device supports communication with the third core network element by using a third data collection application function (DCAF); and/or, a receiving unit, configured to receive second capability information transmitted by the third core network element, where the second capability information indicates whether the terminal device is allowed to communicate with the third core network element by using the third DCAF.

According to a fourteenth aspect, a third core network element is provided, and includes: a receiving unit, configured to receive first capability information transmitted by a terminal device, where the first capability information is used to indicate whether the terminal device supports communication with the third core network element by using a third DCAF; and/or, a transmitting unit, configured to transmit second capability information to the terminal device, where the second capability information indicates whether the terminal device is allowed to communicate with the third core network element by using the third DCAF.

According to a fifteenth aspect, a terminal is provided, and includes a processor, a memory, and a communications interface. The memory is configured to store one or more computer programs. The processor is configured to invoke the computer program in the memory, to cause the terminal device to execute some or all of steps in a method according to the first aspect or the sixth aspect.

According to a sixteenth aspect, a core network element is provided, and includes a processor, a memory, and a communications interface. The memory is configured to store one or more computer programs. The processor is configured to invoke the computer program in the memory, to cause a network device to execute some or all of steps of a core network element (for example, a first core network element or a second core network element) in the methods according to the foregoing aspects.

The foregoing core network element may include a first core network element, a second core network element, an AF, or a third core network element.

According to a seventeenth aspect, a DCAF is provided, and includes a processor, a memory, and a communications interface. The memory is configured to store one or more computer programs. The processor is configured to invoke the computer program in the memory, to cause a network device to execute some or all of the steps in the method according to the eighth aspect.

According to an eighteenth aspect, an NWDAF is provided, and includes a processor, a memory, and a communications interface. The memory is configured to store one or more computer programs. The processor is configured to invoke the computer program in the memory, to cause a network device to execute some or all of the steps in the method according to the eighth aspect.

According to a nineteenth aspect, an embodiment of this application provides a communications system, where the system includes the foregoing terminal and/or the foregoing network elements. In another possible design, the system may further include another device that interacts with the terminal or a network device in the solutions provided in embodiments of this application.

According to a twentieth aspect, an embodiment of this application provides a computer-readable storage medium. The computer-readable storage medium stores a computer program. The computer program causes a terminal to execute some or all of steps of the methods according to the foregoing aspects.

According to a twenty-first aspect, an embodiment of this application provides a computer program product. The computer program product includes a non-transitory computer-readable storage medium that stores a computer program. The computer program is operable to cause a terminal to execute some or all of steps of the methods according to the foregoing aspects. In some implementations, the computer program product may be a software installation package.

According to a twenty-second aspect, an embodiment of this application provides a chip. The chip includes a memory and a processor. The processor may invoke a computer program from the memory and run the computer program, to implement some or all of steps described in the foregoing aspects.

A first core network element may provide a terminal device with an analysis result of a network data analysis service or a monitoring result of a first event.

### BRIEF DESCRIPTION OF DRAWINGS

FIG. 1 is a schematic diagram of a wireless communications system to which embodiments of this application are applicable.

FIG. 2a and FIG. 2b are schematic diagrams of communication between an NWDAF and another NF to which embodiments of this application are applicable.

FIG. 3 is a schematic diagram of a communications system to which embodiments of this application are applicable.

FIG. 4 is a schematic diagram of a neural network to which embodiments of this application are applicable.

FIG. 5 is an architectural diagram of federated learning to which embodiments of this application are applicable.

FIG. 6 is a flowchart of a wireless communication method according to an embodiment of this application.

FIG. 7a is a schematic flowchart of a wireless communication method according to another embodiment of this application.

FIG. 7b is a schematic flowchart of a wireless communication method according to still another embodiment of this application.

FIG. 8 is a schematic flowchart of a wireless communication method according to yet another embodiment of this application.

FIG. 9 is a schematic diagram of a target area and a coverage area of an AF according to an embodiment of this application.

FIG. 10 is a flowchart of a method for obtaining a candidate terminal device through screening according to an embodiment of this application.

FIG. 11 is a flowchart of a method for obtaining a candidate terminal device through screening according to an embodiment of this application.

FIG. 12 is a schematic flowchart of a wireless communication method according to still yet another embodiment of this application.

FIG. 13 is a schematic diagram of a terminal device according to an embodiment of this application.

FIG. 14 is a schematic diagram of a core network element according to an embodiment of this application.

FIG. 15 is a schematic diagram of a DCAF according to an embodiment of this application.

FIG. 16 is a schematic diagram of an AF according to an embodiment of this application.

FIG. 17 is a schematic diagram of a core network element according to an embodiment of this application.

FIG. 18 is a schematic diagram of a terminal device according to an embodiment of this application.

FIG. 19 is a schematic diagram of a core network element according to an embodiment of this application.

FIG. 20 is a schematic structural diagram of a communications apparatus according to an embodiment of this application.

### DESCRIPTION OF EMBODIMENTS

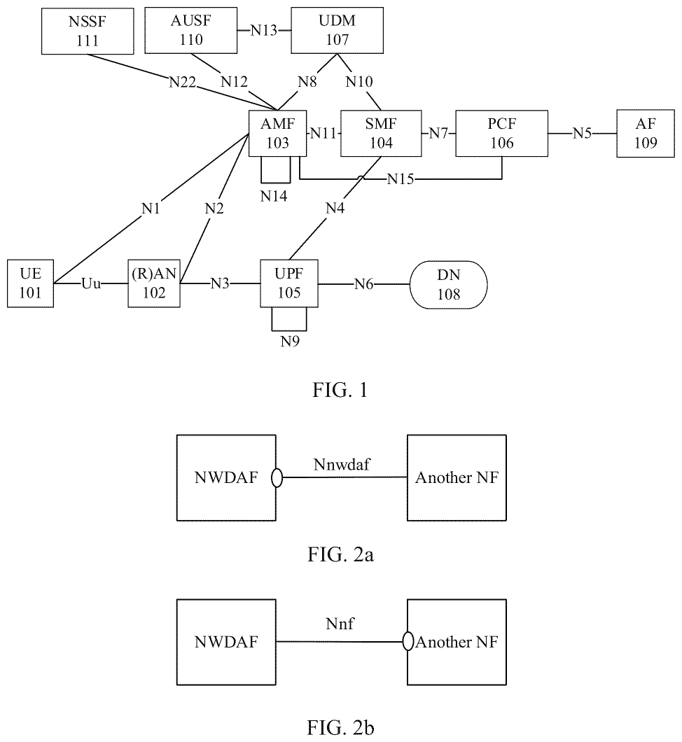

The following describes the technical solutions in this application with reference to the accompanying drawings. For ease of understanding of this application, the following first describes an architecture to which embodiments of this application are applicable, related communication processes, and terms with reference to FIG. 1 to FIG. 5.

FIG. 1 is a schematic diagram of a wireless communications system to which embodiments of this application are applicable. As shown in FIG. 1, a 5th generation (5G) system or a new radio (NR) network architecture released by the 3rd Generation Partnership Project (3GPP) standard group includes: a terminal device (also referred to as a “user equipment (UE))” 101, an access network device 102 (including a radio access network (RAN) or an access network (AN)) that supports a 3GPP technology, a user plane function (UPF) network element 105, an access and mobility management function (AMF) network element 103, a session management function (SMF) network element 104, a policy control function (PCF) network element 106, an application function (AF) network element 109, a data network (DN) 108, a network slice selection function (NSSF) 111, an authentication server function (AUSF) 110, and a unified data management function (UDM) 107.

It should be noted that the network architecture shown in FIG. 1 does not constitute a limitation on the 5G network architecture. In specific implementation, the 5G network architecture may include more or fewer network elements than those shown in the figure, or combine some network elements. In addition, in FIG. 1, an AN or a RAN is represented in a manner of (R)AN.

The terminal device 101 may be a user equipment (UE), a terminal, a handheld terminal, a notebook computer, a subscriber unit, a cellular phone, a smart phone, a wireless data card, a personal digital assistant (PDA) computer, a tablet computer, a wireless modem, a handheld device, a laptop computer, a cordless phone, or a wireless local loop (WLL) station, a machine-type communication (MTC) terminal, a handheld device having a wireless communication function, a computing device, a processing device connected to a wireless modem, an unmanned aerial vehicle, a vehicle-mounted device, a wearable device, a terminal in an internet of things, a virtual reality device, a terminal device in a future communications system (for example, 6G) network, a terminal in a future evolved public land mobile network (PLMN), or the like.

The access network device 102 is an access device for the terminal device to wirelessly access the network architecture, and is mainly responsible for radio resource management on an air interface side, quality of service (QoS) management, data compression and encryption, and the like, for example, a base station NodeB, an evolved base station eNodeB, a base station in a 5G mobile communications system or a new radio (NR) communications system, or a base station in a future mobile communications system.

The UPF network element 105, the AMF network element 103, the SMF network element 104, and the PCF network element 106 are network elements (core network elements for short) of a 3GPP core network. The UPF network element 105 may be referred to as a user plane function network element, and is mainly responsible for transmission of user data. The other network elements may be referred to as control plane function network elements, and are mainly responsible for authorization, authentication, registration management, session management, mobility management, policy control, and the like, to ensure reliable and stable transmission of user data.

The UPF network element 105 (or “UPF” for short) may be configured to forward and receive data of the terminal. For example, the UPF network element may receive data of a service from the data network, and transmit the data to the terminal by using the access network device. Alternatively, the UPF network element may receive user data from the terminal by using the access network device, and forward the user data to the data network. Transmission resources allocated to the terminal and scheduled by the UPF network element are managed and controlled by the SMF network element. A bearer between the terminal and the UPF network element may include: a user plane connection between the UPF network element and the access network device, and a channel established between the access network device and the terminal. The user plane connection is a quality of service (QoS) flow that may be established between the UPF network element and the access network device for data transmission.

The AMF network element 103 (or “AMF” for short) may be configured to manage access of the terminal to the core network, for example, a location update of the terminal, network registration, access control, mobility management of the terminal, and attachment and de-attachment of the terminal. In a case in which the AMF network element provides a service for a session of the terminal, the AMF network element may further provide a control plane storage resource for the session, to store a session identifier, an identity of an SMF network element associated with the session identifier, and the like.

The SMF network element 104 (or “SMF” for short) may be configured to select a user plane network element for the terminal, redirect the user plane network element for the terminal, allocate an internet protocol (IP) address to the terminal, establish a bearer (also referred to as a session) between the terminal and the UPF network element, modify and release a session, and perform QoS control.

The PCF network element 106 (or “PCF” for short) is configured to provide policies, such as QoS policies and slice selection policies, for the AMF network element 103 and the SMF network element 104.

The AF network element 109 (or “AF” for short) is configured to interact with a 3GPP core network element to support an application, affect routing of data, access a network exposure function, interact with the PCF network element to perform policy control, and the like.

The DN 108 may provide a data service for a user by using an IP multi-media service (IMS) network, an internet, or the like. In the DN 108, there may be a plurality of types of application servers (AS), which provide different application services, such as an operator service, an internet access service, or a third-party service. The AS may implement a function of the AF network element.

The NSSF 111 is configured to select a network slice, and supports the following functions: selecting a network slice instance set that serves a UE; determining allowed network slice selection assistance information (NSSAI), and determining, when required, mapping to subscribed single-network slice selection assistance information (S-NSSAI); determining NSSAI that has been configured, and determining, when required, mapping to subscribed S-NSSAI; and determining an AMF set that may be used to query a UE, or determining a list of candidate AMFs based on configuration.

The AUSF 110 is configured to receive a request from the AMF 103 for authenticating an identity of a terminal, request a key from the UDM 107, and then forward the delivered key to the AMF 103 for authentication processing.

The UDM 107 includes functions such as generation and storage of user subscription data and management of authentication data, and supports interaction with an external third-party server.

It should be understood that each network element in FIG. 1 may be a network component in a hardware device, or a software function running on dedicated hardware, or a virtualized function instantiated on a platform (for example, a cloud platform). It should be noted that, in the foregoing network architecture shown in the figure, network elements included in the entire network architecture are merely described by using examples. In embodiments of this application, the network elements included in the entire network architecture are not limited.

In some scenarios, a network data analysis function (NWDAF) network element (“NWDAF” for short) is introduced into the foregoing wireless communications system, to provide a network data analysis function for an operator.

### NWDAF

The NWDAF may collect data of another network element to perform big data analysis. Therefore, an interface between the NWDAF and another network element (NF) is defined. Referring to FIG. 2a, another NF may transmit a request to an NWDAF by using an Nnwdaf interface, to request an analysis result of a network data analysis service (also referred to as an “analysis result of a network data analysis function”). Referring to FIG. 2b, an NWDAF may transmit an analysis result of a network data analysis function to another NF by using an Nnf interface.

In some implementations, the foregoing analysis result of the network data analysis function may be marked by using an analysis identifier (analytic Id). In some other embodiments, the foregoing another NF may be a core network element, for example, may be an AMF, an SMF, a NEF, or a PCF. Certainly, the foregoing another NF may also be a trusted AF or an untrusted AF.

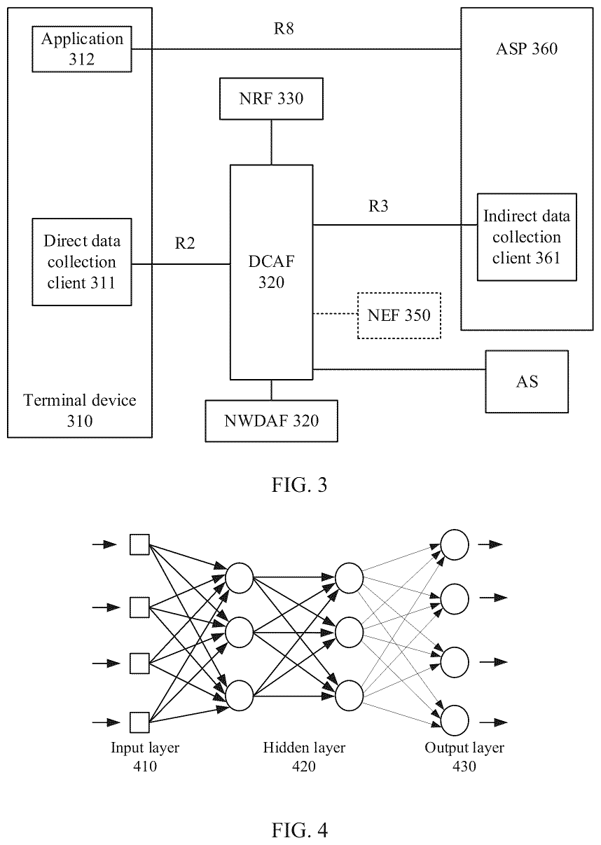

As described above, the NWDAF needs to collect data of another network element to perform big data analysis. In some scenarios, the NWDAF further needs to collect data of a terminal device to perform big data analysis. Currently, a data collection application function (DCAF) is introduced into a wireless communications system to collect data of a terminal device. With reference to FIG. 3, the following describes a process in which a terminal device communicates with an NWDAF by using a DCAF.

For ease of understanding, an architecture shown in FIG. 3 is first described. The architecture shown in FIG. 3 includes a terminal device 310, a DCAF 320, a network repository function (NRF) 330, an NWDAF 340, a network exposure function 350, an application service provider (ASP) 360, and an AS 370.

The NEF network element 350 (“NEF” for short) is configured to expose an event and a function of another NF to an AF, a third party, edge calculation, or the like. The NRF network element 330 (“NRF” for short) is mainly responsible for discovery or maintenance of another NF.

Referring to the architecture shown in FIG. 3, communication between the terminal device and the DCAF 320 may include two interaction manners: a direct interaction manner and an indirect interaction manner.

In the direct interaction manner, the terminal device may directly transmit data to the DCAF 320 by using a direct data collection client 311. The direct data collection client 311 may communicate with the DCAF 320 by using R2.

In the indirect interaction manner, the terminal device may transmit data to the ASP 360 by using an application 312, and the ASP 360 transmits the data to the DCAF 320 by using an indirect data collection client 361. The application 312 may communicate with the ASP 360 by using R8, and the indirect data collection client 361 may communicate with the DCAF by using R3.

In some implementations, after registering with a 5GS and establishing a PDU session, the terminal device may transmit data to the DCAF. In some other implementations, the terminal device communicates with a first DCAF by using an application connection (for example, HTTP) of a user plane.

### Neural Network

In recent years, artificial intelligence (AI) research, represented by a neural network, has made great achievements in many fields, and will also play an important role in people's production and life for a long time. Common neural networks include a convolutional neural network (CNN), a recurrent neural network (RNN), a deep neural network (DNN), and the like.

With reference to FIG. 4, the following describes a neural network to which embodiments of this application are applicable. The neural networks shown in FIG. 4 may be classified into three types according to locations of different layers: an input layer 410, a hidden layer 420, and an output layer 430. Generally, the first layer is the input layer 410, the last layer is the output layer 430, and the middle layer between the first layer and the last layer is the hidden layer 420.

The input layer 410 is configured to input data. The input data may be, for example, a receive signal received by a receiver. The hidden layer 420 is configured to process the input data, for example, perform decompression processing on a received signal. The output layer 440 is configured to output processed output data, for example, output a decompressed signal.

As shown in FIG. 4, the neural network includes a plurality of layers, and each layer includes a plurality of neurons. Neurons between two layers may be fully connected, or may be partially connected. For connected neurons, an output of neurons at an upper layer may be used as an input of neurons at a lower layer.

With continuous development of neural network research, a neural network deep learning algorithm is also proposed in recent years. A large quantity of hidden layers are introduced into a neural network to form a DNN. More hidden layers enable the DNN to better describe a complex situation in a real world. In theory, a model with a larger quantity of parameters has higher complexity and also a larger capacity, which means that the model can complete a more complex learning task. This neural network model is widely applied in aspects such as pattern recognition, signal processing, optimization combination, and anomaly detection.

### Federated Learning (FL)

If a neural network is expected to have higher performance (for example, a higher recognition rate in the image recognition field), a large amount of training data is required to train an AI model (for example, a neural network model or a machine learning model). However, in real life, only a few data holders (for example, giant companies) have a large amount of data, which may be used as training data of a neural network model, and can meet a requirement for neural network training. A large majority of data holders (for example, small and medium-sized enterprises) have a relatively small amount of data, and cannot provide enough training data for training a neural network model. Therefore, free flowing of data under a condition of security and compliance becomes a tendency, and federated learning emerges.

Federated learning is essentially a distributed machine learning technology or a distributed machine learning framework, and aims to implement collaborative modeling (or collaborative training on an AI model) to improve a training effect of the AI model on a basis of ensuring data privacy security and legal compliance. The following describes a federated learning process by using an example in which a terminal device performs federated learning. It should be noted that a terminal device (also referred to as a “federated terminal”) that participates in federated learning may be the terminal device 101 shown in FIG. 1.

With continuous improvement of performance of a sensor (for example, a camera) on the terminal device 101, an increasing quantity of terminal devices 101 may collect valuable training data necessary for AI model training. For training tasks of many AI models, training data collected by the terminal device 101 has great significance for training a global AI model.

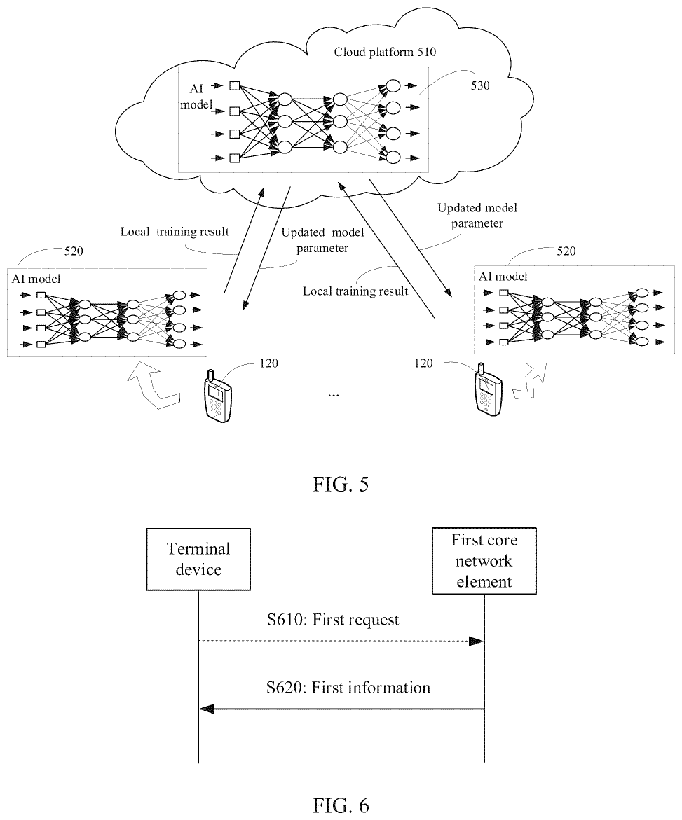

FIG. 5 is an architectural diagram of federated learning to which embodiments of this application are applicable. The federated learning architecture shown in FIG. 5 includes a cloud platform 510 and terminal devices 120. An FL server may be deployed in the cloud platform 510, and the FL server may train an AI model by using federated learning. In some implementations, the FL server may communicate with the terminal devices 101 by using some communications systems (for example, a 5G system or a 6G system).

Referring to FIG. 5, a process of training an AI model by using federated learning may be roughly divided into a local training process 520 and a global update process 530. In the local training process 520, the terminal devices 101 may locally train the AI model by using collected data, to obtain local training results (for example, a model parameter such as a gradient of a DNN). Then, the terminal devices 101 transmit first training results to the FL server, to enter the global update process 530. Correspondingly, in the global update process 530, the FL server may update a model parameter of the AI model by using a local training result reported by each terminal device 101.

It should be noted that in the local training process 520, the terminal devices 101 perform a plurality of rounds of iterations on the AI model. In each round of iteration, the terminal devices 101 may train, by using local training data, an AI model downloaded from the FL server, to obtain local training results of the AI model, and transmit the obtained local training results to the FL server by using an uplink channel in the foregoing communications system. Correspondingly, the FL server performs weighted aggregation on the training result reported by each terminal device 101, and updates the model parameter of the AI model. Then, the FL server transmits the updated model parameter to the terminal devices 101 by using a downlink channel in the communications system. Correspondingly, the terminal devices 101 perform a next round of iterative training on the AI model based on the training data and the updated model parameter.

### Transfer Learning

An objective of transfer learning is to apply knowledge or a pattern learned from a field or a task to different but related fields or problems. Main ideas of transfer learning include migrating labeled data or a knowledge structure from a related field, and completing or improving a learning effect of a target field or task.

As described above, currently, a first core network element provides an operator with only a network data analysis service or a monitoring result of an event, resulting in a relatively limited application range of the first core network element.

Therefore, to avoid the foregoing problem, this application provides a wireless communication solution. A first core network element may provide a terminal device with a network data analysis service or a monitoring result of a first event, to expand an application range of the first core network element and improve utilization of the first core network element.

With reference to FIG. 6, the following describes a wireless communication method according to an embodiment of this application. FIG. 6 is a flowchart of a wireless communication method according to an embodiment of this application. The method shown in FIG. 6 includes step S610 and step S620.

In step S610, a terminal device transmits a first request.

The first request is used to request first information, where the first information may include an analysis result of a first network data analysis service or a monitoring result of a first event.

If the first information includes the analysis result of the first network data analysis service, alternatively, the first request is used to request the analysis result of the first network data analysis service, or the first request is used by the terminal device to request the analysis result of the first network data analysis service. In some implementations, the foregoing first information may be referred to as “Ndcaf_DataReportingProvisioning”.

In some implementations, the foregoing analysis result may include one or more of the following analysis results: an analysis result of quality of service (QOS) sustainability analysis; an analysis result of user data congestion analysis; an analysis result of network performance analysis; an analysis result of terminal-related network analysis (UE-related network analytics); or the like. Certainly, another analysis result may also be applicable to the solutions in embodiments of this application.

If the first information includes the monitoring result of the first event, alternatively, the first request is used to request the monitoring result of the first event, or the first request is used by the terminal device to request the monitoring result of the first event.

In some implementations, the foregoing monitoring result of the first event (also referred to as an “event-triggered monitoring result”) may include a monitoring result that may be provided by an AMF, an SMF, or a PCF, for example, a monitoring result related to a current location of the terminal; a monitoring result related to a location change of the terminal; a monitoring result related to entering or leaving an area of the terminal; a monitoring result related to a change of accessing a core network; a monitoring result related to a change of an access type; a monitoring result related to that the SMF decides to trigger PDU session modification; or a monitoring result related to that the AMF decides to trigger a RAT or a system replacement command for access of the terminal.

In some scenarios, due to some reasons, the SMF decides to trigger PDU session modification. The reasons may include: to modify a QoS parameter of a QoS flow, to establish or delete a QoS flow, to update a QoS flow binding rule, and the like. In embodiments of this application, when deciding to initiate a PDU session modification procedure, the SMF may transmit a monitoring result of this event to the terminal or an application server in advance or immediately. In this way, the terminal may perform adjustment to ensure that an application service is not affected as much as possible.

In addition, due to some reasons, the AMF decides to trigger a RAT or a system replacement command for access of the terminal. In this case, the AMF may notify the terminal device by using the monitoring result of the event.

It should be understood that the foregoing first event may be an event that has occurred or is to occur. In addition, in addition to the monitoring results of the foregoing listed events, a monitoring result of another event may also be applicable to embodiments of this application, which is not limited in embodiments of this application.

In a case in which the terminal device requests the first information from a first core network element, there are many manners of transmitting the first request. In some implementations, the terminal device may transmit the first request to the first core network element by using a non-access stratum message. In some other implementations, to reduce changes to an existing communication protocol, a manner of transmitting the first request may be reusing the manner of transmitting terminal data described above. That is, the terminal device may transmit the first request to a first DCAF, and the first DCAF assists the terminal device in requesting the first information from the first core network element. When requesting the first information, the first DCAF may generate a second request based on the first request. Certainly, the first DCAF may also directly request the first information from the first core network element based on the first request. Details are described in the following. For brevity, details are not described herein again.

In addition, in a case in which the terminal device requests the first information with assistance of the first DCAF, a manner of interaction between the terminal device and the first DCAF may be divided into two manners: direct interaction and indirect interaction. In the direct interaction manner, the terminal device may directly transmit the first request to the first DCAF, or the terminal device may transmit the first request to the first DCAF by using an R2 interface. Therefore, this transmission manner of direct interaction may reduce a delay of transmitting the first request.

In the indirect interaction manner, the terminal device may transmit the first request to an ASP (also referred to as a “first ASP”), and then the ASP transmits the first request to the first DCAF, or the terminal device may transmit the first request to the ASP by using an R8 interface, and then the ASP transmits the first request to the first DCAF by using an R3 interface. In this transmission manner of indirect interaction, the terminal device may not set a DCAF client, to reduce changes to the terminal device and improve an application range of the solution.

In step S620, the first core network element transmits the first information to the terminal device.

There are many manners of transmitting the first information. In some implementations, the first core network element may transmit the first information to the terminal device by using a non-access stratum message. In some other implementations, to reduce changes to an existing communication protocol, a transmission path for transmitting the first information may be reusing a transmission path for transmitting terminal data described above. That is, the first core network element may transmit the first information to the first DCAF, and the first DCAF transmits the first information to the terminal device.

In addition, in a case in which the terminal device receives the first information with assistance of the first DCAF, a manner of interaction between the terminal device and the first DCAF may be divided into two manners: direct interaction and indirect interaction. In the direct interaction manner, the first DCAF may directly transmit the first information to the terminal device, or the first DCAF may transmit the first information to the terminal device by using the R2 interface. Therefore, this transmission manner of direct interaction may reduce a delay of transmitting the first information.

In the indirect interaction manner, the first DCAF may transmit the first information to an ASP (also referred to as a “second ASP”), and then the ASP transmits the first information to the terminal device, or the first DCAF transmits the first information to the ASP by using an R3 interface, and then the ASP transmits the first information to the terminal device by using an R8 interface. In this transmission manner of indirect interaction, the terminal device may not set a DCAF client, to reduce changes to the terminal device and improve an application range of the solution.

In some implementations, if the foregoing first information includes the analysis result of the first network data analysis service, information that carries the analysis result of the first network data analysis service may be referred to as a “data report (Data Reporting)”.

In this embodiment of this application, a first core network element may provide a terminal device with an analysis result of a network data analysis service or a monitoring result of a first event. Compared with a conventional solution in which a first core network element provides an operator with only a network data analysis service or a monitoring result of a first event, the technical solution provided in this embodiment of this application helps expand an application range of the first core network element and improve utilization of the first core network element.

Based on a difference in content included in the first information, information that may be carried in the first request slightly varies. The following separately describes content carried in the first request by using examples in which the first information includes the analysis result of the first network data analysis service or the monitoring result of the first event.

If the foregoing first information includes the analysis result of the first network data analysis service, the first core network element may be a first NWDAF. In some implementations, the foregoing first request may carry one or more of the following information: a request type of the first request; a first identifier of the first network data analysis service (also referred to as a “first analysis identifier (analytics ID)”); an analysis condition of the first network data analysis service (which may be represented as a “filter”); or an identity of the terminal device (which may be represented as a “UE ID”).

The request type of the first request includes a request/response type and a subscribe/notify type. The request/response type may be understood as a one-time request and response. That is, after the terminal device transmits the first request, the first NWDAF transmits a response message for the first request. The subscribe/notify type may be understood as a one-time request and multi-time response type. That is, after the terminal device transmits the first request, the first NWDAF transmits a plurality of response messages for the first request.

The first identifier of the first network data analysis service is used to identify the first network data analysis service, or the first network data analysis service is used to indicate analysis content of the first network data analysis service, or the first network data analysis service is used to indicate the analysis result of the first network data analysis service. In some implementations, the analysis result of the first network data analysis service may include one or more of the following analysis results: mobility information of the terminal device; a network congestion situation; a communication capability of the terminal device; a maintenance situation of a QoS-related parameter in a network; or the like.

The analysis condition (also referred to as a “filter condition”) of the first network data analysis service is used to limit an analysis range of the first network data analysis service. For example, when the analysis result of the first network data analysis service is mobility of the terminal device, the analysis condition of the first network data analysis service may be a terminal device located in an area range A. In this case, the analysis result of the first network data analysis service may be performed for a terminal device located in the area range A.

For another example, when the analysis result of the first network data analysis service is a communication capability of the terminal device, the analysis condition of the first network data analysis service may be a communication capability of a terminal device within a time period A. In this case, the analysis result of the first network data analysis service may be the communication capability of the terminal device within the time period A.

The identity of the terminal device is used to identify a terminal device that requests the analysis result of the first network data analysis service.

Correspondingly, a receive end (for example, the first DCAF or the first NWDAF) of the first request may determine, based on the first request, the first network data analysis service requested by the terminal device.

For example, the first network data analysis service may be a network data analysis service provided for the terminal device by default. In this case, the first request may carry only the type of the first request. For another example, when the first request carries the first identifier of the first network data analysis service, the first network data analysis service may be determined based on the first identifier. For another example, the first network data analysis service may be a network data analysis service provided for the terminal device by default. In this case, the first request may carry only the analysis condition of the first network data analysis service. For another example, a correspondence between each terminal device and a network data analysis service is configured in advance. In this case, the first request may carry only the identity of the terminal device, and the first network data analysis service is determined by using the identity of the terminal device and the correspondence between the terminal device and the network data analysis service.

If the foregoing first information includes the monitoring result of the first event, the first core network element may be one of a PCF, an AMF, or an SMF. In some implementations, the foregoing first request may carry one or more of the following information: a request type of the first request; an event trigger identifier of the first event; or an identity of the terminal device.

The request type of the first request includes a request/response type and a subscribe/notify type. The request/response type may be understood as a one-time request and response. That is, after the terminal device transmits the first request, the first core network element transmits a response message for the first request. The subscribe/notify type may be understood as a one-time request and multi-time response type. That is, after the terminal device transmits the first request, the first core network element transmits a plurality of response messages for the first request.

The event trigger identifier of the first event is used to identify the first event.

The identity of the terminal device is used to identify a terminal device that requests the monitoring result of the first event.

Correspondingly, a receive end of the first request (for example, the first DCAF, the PCF, the AMF, or the SMF) may determine, based on the first request, the monitoring result of the first event that is requested by the terminal device.

For example, the first event may be a default event. In this case, the first request may carry only the type of the first request. For another example, when the first request carries the event trigger identifier of the first event, the first event may be determined based on the event trigger identifier of the first event. For another example, a correspondence between each terminal device and an event is configured in advance. In this case, the first request may carry only the identity of the terminal device, and the first event is determined by using the identity of the terminal device and the correspondence between the terminal device and the event.

As described above, after receiving the first request transmitted by the terminal device, the first DCAF may directly transmit the first request to the first core network element, or may generate the second request based on the first request, and transmit the second request to the first core network element. That is, the foregoing step S610 includes: transmitting, by the terminal device, the first request to the first DCAF. The first request is used by the first DCAF to generate the second request, and the second request is transmitted by the first DCAF to the first core network element.

It should be noted that the second request may also be used by the terminal device to request the first information. In addition, a type of information included in the second request may be partially or completely the same as a type of information included in the foregoing first request. A difference between the second request and the first request may include a difference in specific content of the information carried in the requests. The following uses an example in which the first information includes the analysis result of the first network data analysis service for description.

In some scenarios, to protect privacy of a user, the first identifier in the foregoing first request may be an external analysis identifier. In this case, in a process of transmitting the first request, an untrusted network element cannot learn, by using the external analysis identifier, of the first network data analysis service requested by the terminal device. For a trusted network element, the first identifier in the first request needs to be converted into an internal analysis identifier (also referred to as a “second identifier”) of the first network data analysis service, and the internal analysis identifier is carried in the second request, so that the first NWDAF learns of the first network data analysis service requested by the terminal device. The following separately uses examples in which the trusted network element is a first DCAF or a first NEF for description.

It is assumed that the first DCAF is a trusted network element, and a first identifier is an external analysis identifier. After the first DCAF receives the first request transmitted by the terminal device, the first DCAF converts the first identifier in the first request into the second identifier, carries the second identifier in the second request, and transmits the second request to the first NWDAF. In some implementations, the second request may be referred to as “Nnwdaf_AnalyticsSubscription_Subscribe”. In addition, the second request may be transmitted to the first NWDAF by using an Nnwdaf interface.

It is assumed that the first DCAF is an untrusted network element, and the first identifier is the external analysis identifier. After the first DCAF receives the first request transmitted by the terminal device, the first DCAF transmits the first identifier in the first request to the first NEF. Correspondingly, the first NEF may convert the first identifier into the second identifier, carry the second identifier in the second request, and transmit the second request to the first NWDAF. In some implementations, a request that carries the first identifier transmitted by the first DCAF to the first NEF may be referred to as “Nnef_AnalyticsExposure_Subscribe”. In addition, the request may be transmitted to the first NEF by using an Nnef interface. In some other implementations, the request that carries the second identifier transmitted by the first NEF to the first NWDAF may be referred to as “Nnwdaf_AnalyticsSubscription_Subscribe”. In addition, the request may be transmitted by using an Nnwdaf interface.

In some scenarios, the first DCAF may not know the first core network element that may provide information for the terminal device. Therefore, the first DCAF may transmit an NF discovery request (which may be referred to as “Nnrf_NFDiscovery_Request”) to an NRF, to request discovery of the first core network element. Correspondingly, in response to the NF discovery request, the NRF may transmit an NF discovery response (which may be referred to as “Nnrf_NFDiscovery_ Response”) to the first DCAF, to indicate the first core network element.

For example, the first core network element is the first NWDAF. The first DCAF may transmit an NF discovery request to the NRF, to request discovery of an NWDAF that may provide the first network data analysis service for the terminal device. Correspondingly, in response to the NF discovery request, the NRF may transmit an NF discovery response to the first DCAF, to indicate that the first NWDAF may provide the first network data analysis service for the terminal device.

In some other scenarios, the first core network element may not independently provide the first information for the terminal device. Therefore, the first core network element needs to cooperate with another core network element to provide the first information for the terminal device. In some implementations, the another core network element may transmit owned information to the first core network element, and the first core network element processes the collected information to obtain the first information, and then transmits the first information to the terminal device. In some other implementations, the another core network element may directly transmit the first information to the first core network element. Correspondingly, the first core network element only needs to transmit the first information to the terminal device.

For example, the first information includes the first network data analysis service. After the first NWDAF learns that the terminal device requests the analysis result of the first network data analysis service, if the first NWDAF cannot independently provide the foregoing analysis result for the terminal device, in some implementations, the first NWDAF may transmit a cooperation request to another NWDAF, to obtain data of the another NWDAF, perform analysis based on the obtained data, to obtain the analysis result of the first network data analysis service, and then transmit the analysis result of the first network data analysis service to the terminal device by using the first DCAF.

In some other implementations, the first NWDAF may transmit a cooperation request to another NWDAF, to obtain an analysis result of the first network data analysis service of the another NWDAF, and transmit the analysis result of the first network data analysis service to the terminal device by using the first DCAF.

In addition, the first NWDAF may transmit a message including the analysis result of the first network data analysis service to the first DCAF by using an Nnwdaf interface. In addition, the request may be referred to as “Nnwdaf_AnalyticsSubscription_Notify”.

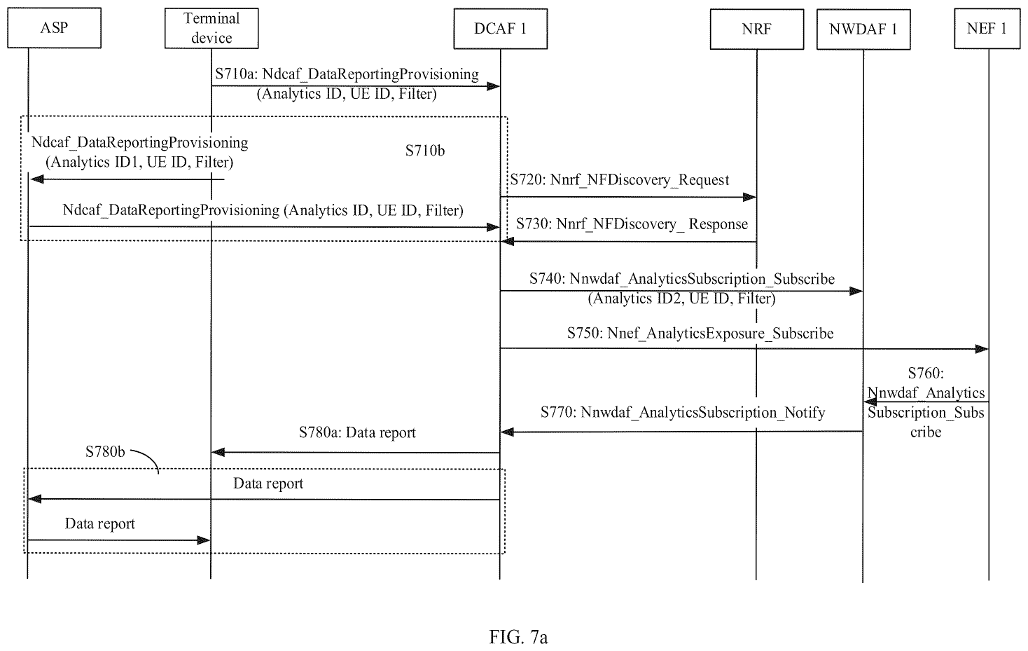

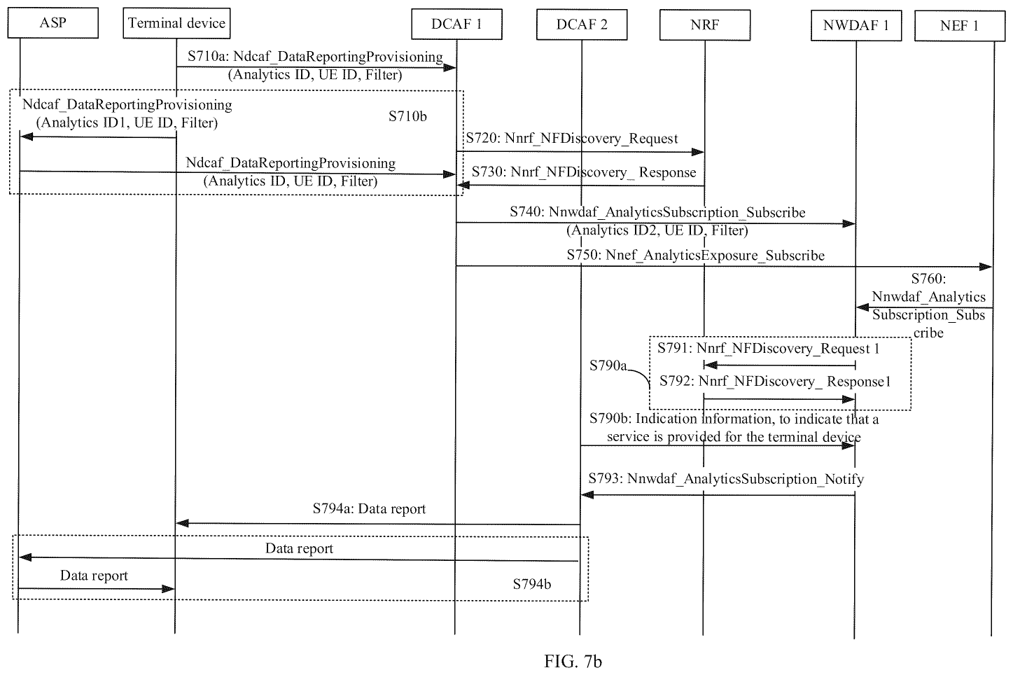

For ease of understanding of this application, the following describes a method according to an embodiment of this application by using an example in which first information includes an analysis result 1 of a network data analysis service with reference to FIG. 7a and FIG. 7b. In addition, terms and information transmission manners related to FIG. 7a and FIG. 7b have been described above in detail. For brevity, details are not described in the following. The method shown in FIG. 7a includes step S710 to step S780.

In steps S710a to S710b, a terminal device transmits a request 1 (also referred to as “Ndcaf_DataReportingProvisioning”).

The foregoing request 1 is used to request the analysis result 1 of the network data analysis service. In addition, the request 1 includes an external analysis identifier (represented by “Analytics ID1”) of the analysis result 1 of the network data analysis service; an analysis condition (represented by “Filter”) of the analysis result 1 of the network data analysis service; and an identity (represented by “UE ID”) of the terminal device.

It should be noted that the terminal device may transmit the request 1 to a DCAF 1 in an indirect interaction manner or a direct interaction manner. For the indirect interaction manner, refer to step S710b in FIG. 7a. The terminal device transmits the request Ndcaf_DataReportingProvisioning to an ASP, and then the ASP transmits the request Ndcaf_DataReportingProvisioning to the DCAF 1. For the direct interaction manner, refer to step S710a in FIG. 7a. The terminal device directly transmits the request Ndcaf_DataReportingProvisioning to the DCAF 1.

In step S720, the DCAF 1 transmits an NF discovery request (also referred to as “Nnrf_NFDiscovery_Request”) to an NRF.

The NF discovery request is used to request discovery of an NWDAF that may provide the terminal device with the analysis result 1 of the network data analysis service.

In step S730, the NRF transmits an NF discovery response (also referred to as “Nnrf_NFDiscovery_ Response”) to the DCAF 1.

The NF discovery response is used to indicate that an NWDAF 1 may provide the terminal device with the analysis result 1 of the network data analysis service.

In the following, based on whether the DCAF 1 is a trusted DCAF, interaction between the DCAF 1 and the NWDAF 1 is divided into two implementations. In an implementation 1, if the DCAF 1 is a trusted DCAF, step S740 may be executed. In an implementation 2, if the DCAF 1 is an untrusted DCAF, step S750 and step S760 may be executed.

In step S740, the DCAF 1 transmits a request 2 (also referred to as “Nnwdaf_AnalyticsSubscription_Subscribe”) to the NWDAF 1.

The foregoing request 2 is used to request the analysis result 1 of the network data analysis service for the terminal device.

If the DCAF 1 is a trusted DCAF, the DCAF 1 may convert an external analysis identifier in the request 1 into an internal analysis identifier. Correspondingly, the foregoing request 2 may carry an internal analysis identifier (represented by “Analytics ID2”) of the analysis result 1 of the network data analysis service; the analysis condition (represented by “Filter”) of the analysis result 1 of the network data analysis service; and the identity (represented by “UE ID”) of the terminal device.

In step S750, the DCAF 1 transmits a request 3 (also referred to as “Nnef_AnalyticsExposure_Subscribe”) to a NEF 1.

The foregoing request 3 carries the external analysis identifier of the analysis result 1of the network data analysis service.

In step S760, the NEF 1 transmits a request 4 (also referred to as “Nnwdaf_AnalyticsSubscription_Subscribe”) to the DCAF 1.

The request 4 is used to request the analysis result 1 of the network data analysis service for the terminal device.

The NEF 1 may convert the external analysis identifier in the request 1 into the internal analysis identifier, carry the internal analysis identifier in the request 4, and transmit the request 4 to the NWDAF 1.

In step S770, the NWDAF 1 transmits the analysis result 1 (also referred to as “Nnwdaf_AnalyticsSubscription_Notify”) of the network data analysis service to the DCAF 1.

In steps S780a to S780b, the DCAF 1 transmits a data report (also referred to as “DataReporting”) to the terminal device, where the data report includes the analysis result 1 of the network data analysis service.

It should be noted that the DCAF 1 may transmit the analysis result 1 of the network data analysis service to the terminal device in an indirect interaction manner or a direct interaction manner. For the indirect interaction manner, refer to step S780b in FIG. 7a. The DCAF 1 transmits DataReporting to the ASP, and the ASP transmits DataReporting to the terminal device. For the direct interaction manner, refer to step S780a in FIG. 7a. The DCAF 1 directly transmits DataReporting to the terminal device.

In some other scenarios, a mobile location of the terminal device may change, for example, moving from a coverage range of the DCAF 1 to a coverage range of a DCAF 2. In this case, the terminal device may transmit the first request to a first NWDAF by using a first DCAF, but needs to receive, from a second DCAF, an analysis result of a network data analysis service that is transmitted by the first NWDAF. In this case, how the first NWDAF learns of a DCAF that may provide a service for the terminal device is an urgent problem to be resolved.

To resolve the foregoing problem, an embodiment of this application provides two manners to notify the first NWDAF of a DCAF that currently provides a service for the terminal device. In a manner 1, after the terminal device moves to a coverage range of the second DCAF, the second DCAF may proactively notify the first NWDAF that the second DCAF may provide a service for the terminal device. In a manner 2, the first NWDAF may interact with the NRF to discover the DCAF that may currently provide a service for the terminal device. For example, the first NWDAF may transmit an NF discovery request (also referred to as “Nnrf_NFDiscovery_Request”) to the NRF, to request discovery of the DCAF that provides a service for the terminal device. In response to the NF discovery request, the NRF may transmit an NF discovery response (also referred to as “Nnrf_NFDiscovery_ Response”) to the first NWDAF, to indicate that the second DCAF may provide a service for the terminal device.

For ease of understanding, the following describes a wireless communication method according to an embodiment of this application with reference to FIG. 7b. It should be noted that a same number is used for a same process in the flowchart shown in FIG. 7b and the flowchart shown in FIG. 7a. For brevity, details are not described in the following. A difference between the method procedure shown in FIG. 7b and the method procedure shown in FIG. 7a may be understood as starting from step S770, that is, steps S790a to S794b in the method shown in FIG. 7b may replace steps S770 to S780b in FIG. 7a. FIG. 7b mainly describes a method for discovering a second DCAF (also referred to as a “DCAF 2”) by a first NWDAF (also referred to as an “NWDAF 1”).

The foregoing manner 2 may correspond to step S790a. In step S790a, the NWDAF 1 determines, by interacting with an NRF, the DCAF that provides a service for the terminal device. The foregoing step S790a includes step S791 and step S792.

In step S791, the NWDAF 1 transmits an NF discovery request (also referred to as “Nnrf_NFDiscovery_Request1”) to the NRF.

The NF discovery request is used to request discovery of the DCAF that may provide a service for the terminal device.

In step S792, the NRF transmits an NF discovery response (also referred to as “Nnrf_NFDiscovery_ Response1”) to the NWDAF 1.

The NF discovery response is used to indicate that the DCAF 2 may provide a service for the terminal device.

The foregoing manner 1 may correspond to step S790b. In step S790b, after the terminal device moves to a coverage range of the DCAF 2, the DCAF 2 may transmit indication information to the NWDAF 1, to indicate that the DCAF 2 provides a service for the terminal device.

In step S793, the NWDAF 1 transmits the analysis result 1 (also referred to as “Nnwdaf_AnalyticsSubscription_Notify”) of the network data analysis service to the DCAF 2.

In steps S794a to S794b, the DCAF 2 transmits a data report to the terminal device, where the data report includes the analysis result 1 of the network data analysis service.

It should be noted that the DCAF 2 may transmit the analysis result 1 of the network data analysis service to the terminal device in an indirect interaction manner or a direct interaction manner. For the indirect interaction manner, refer to step S794b in FIG. 7b. The DCAF 2 transmits DataReporting to the ASP, and the ASP transmits DataReporting to the terminal device. For the direct interaction manner, refer to step S794a in FIG. 7b. The DCAF 2 directly transmits DataReporting to the terminal device.

In some scenarios, an AF needs to perform calculation based on data of a terminal device, and the data of the terminal device that is used directly affects accuracy of the calculation. Therefore, how to obtain a terminal device through screening is an urgent problem to be resolved.

For example, in a process of training an AI model (for example, training the AI model based on federated learning or transfer learning), the AF needs to train the AI model by using data of a terminal device as training data. In this case, quality of the training data (for example, diversity of the training data) directly affects precision of the AI model. If terminal devices that participate in the training are not screened, data provided by the terminal devices that participate in the training may be relatively similar, which ultimately affects precision of the AI model.

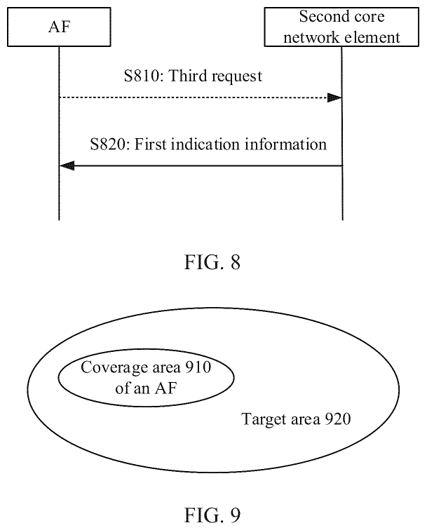

To avoid the foregoing problem, this application further provides a wireless communication method. In this method, a core network element (also referred to as a “second core network element”) may assist an AF in obtaining a terminal device (also referred to as a “candidate terminal device”) through screening. With reference to FIG. 8, the following describes a wireless communication method according to an embodiment of this application. The method shown in FIG. 8 includes step S810 and step S820.

In step S810, an AF transmits a third request.

The foregoing third request is used to request a candidate terminal device, or the foregoing third request is used by the AF to request the candidate terminal device. In some implementations, the foregoing third request may be referred to as “NWDAF Analytics Info request”.

In some other implementations, the foregoing third request may be transmitted by the AF to a second NEF. In some other implementations, the third request may be transmitted by the AF to a second NWDAF.

In step S820, a second core network element transmits first indication information to the AF.

The foregoing first indication information is used to indicate the candidate terminal device. The candidate terminal device may include one terminal device or a plurality of terminal devices.

The foregoing second core network element may be the second NEF or the second NWDAF.

In this embodiment of this application, the AF may request the candidate terminal device from the second core network element, to assist the AF in obtaining the candidate terminal device through screening with assistance of the second core network element, thereby improving accuracy of calculation executed by the AF.

To improve accuracy of obtaining a candidate terminal device through screening, in a process of requesting to obtain the candidate terminal device through screening, the AF may further indicate a screening condition of obtaining the candidate terminal device through screening. In some implementations, to reduce a quantity of times of information transmission, the foregoing screening condition may be carried in the third request. Certainly, in some other implementations, the foregoing screening condition may be further transmitted by using separate information, which is not limited in embodiments of this application.

In some implementations, the foregoing screening condition includes one or more of the following conditions: a terminal device located in a coverage range of the AF; a terminal device whose historical moving area at least partially overlaps a target area; a terminal device whose predicted future moving area at least partially overlaps the target area; a terminal device that stays in the target area for duration that is greater than or equal to target duration; or a terminal device located in the target area in target time; or a terminal group used to obtain the candidate terminal device through screening. The following separately describes the foregoing screening conditions.

Screening condition 1: a terminal device located in a coverage range of the AF. Correspondingly, a candidate terminal device obtained after screening includes the terminal device located in the coverage range of the AF.

Generally, the AF can communicate with only a terminal device in the coverage range. Therefore, for subsequent communication with the candidate terminal device, the AF may limit, by using the screening condition 1, that a selected candidate terminal device is located in the coverage range of the AF.

Screening condition 2: a terminal device whose historical moving area at least partially overlaps a target area. Correspondingly, a candidate terminal device obtained after screening includes the terminal device whose historical moving area at least partially overlaps the target area.

The foregoing historical moving area may be understood as including an area that the terminal device passes when moving within a past time. For example, the historical moving area may include a street that the terminal device visited within a historical time. For another example, the historical moving area may include a motion track of the terminal device within the historical time, that is, a historical motion track of the terminal device.

The foregoing target area may be understood as an area of interest for calculation executed by the AF. Therefore, the target area may also be referred to as an “interested area”. An AI model training scenario is used as an example. The foregoing target area may be understood as an area for collecting training data. Generally, the area for collecting the training data is the same as a valid area of the AI model. Therefore, the target area may be further understood as the valid area of the AI model, that is, the AI model may process data in the target area.

That the foregoing historical moving area at least partially overlaps the target area may include: The historical moving area completely overlaps the target area, or the historical moving area partially overlaps the target area.

When the historical moving area completely overlaps the target area, the historical moving area is exactly the same as the target area. For example, the target area is a street A, and correspondingly, a historical moving area of the candidate terminal device is the street A.

When the historical moving area partially overlaps the target area, there may be three cases. In a case 1, the historical moving area includes the target area. For example, the target area is a road R, and correspondingly, the historical moving area of the candidate terminal device includes the road R and a road E. In a case 2, the target area includes the historical moving area. For example, the target area is a road R and a road E, and correspondingly, the historical moving area of the candidate terminal device is the road E. In a case 3, a part of the historical moving area overlaps a part of the target area. For example, the target area is a road R, the historical moving area is a road E, and some road segments of the road R overlap some road segments of the road E.

Screening condition 3: a terminal device whose predicted future moving area at least partially overlaps the target area. Correspondingly, a candidate terminal device obtained after screening includes the terminal device whose future moving area at least partially overlaps the target area.

The foregoing future moving area may be understood as including an area that the terminal device will pass when moving within a future time. For example, the future moving area may include a street that the terminal device will visit within a future time. For another example, the future moving area may include a motion track of the terminal device within the future time, that is, a future motion track of the terminal device.

It should be noted that the foregoing future moving area may be predicted based on information about the terminal device. Therefore, the foregoing future moving area may also be referred to as a “predicted future moving area”. In addition, for an explanation of the target area, refer to related description in the screening condition 2. For brevity, details are not described in the following.

When the future moving area completely overlaps the target area, the future moving area is exactly the same as the target area. For example, the target area is a street A, and correspondingly, a future moving area of the candidate terminal device is the street A.

When the future moving area partially overlaps the target area, there may be three cases. In a case 1, the future moving area includes the target area. For example, the target area is a road R, and correspondingly, the future moving area of the candidate terminal device includes the road R and a road E. In a case 2, the target area includes the future moving area. For example, the target area is a road R and a road E, and correspondingly, the future moving area of the candidate terminal device is the road E. In a case 3, a part of the future moving area overlaps a part of the target area. For example, the target area is a road R, the future moving area is a road E, and some road segments of the road R overlap some road segments of the road E.

Screening condition 4: a terminal device that stays in the target area for duration that is greater than or equal to target duration. Correspondingly, a candidate terminal device obtained after screening stays in the target area for duration that is greater than or equal to the target duration.

In some scenarios, data of a terminal device that stays in the target area for a longer time has a greater effect on improving precision of calculation. Therefore, a time during which a terminal device stays in the target area may be limited by using the screening condition 4.

Screening condition 5: a terminal device located in the target area in target time. Correspondingly, a candidate terminal device obtained after screening is the terminal device located in the target area in target time.

In some scenarios, when a terminal device is located in the target area in target time, data of the terminal device has a greater effect on improving precision of calculation. Therefore, a time period during which the terminal device is in the target area may be limited by using the screening condition 5. It should be noted that the foregoing target time may be a period of time, or may be a moment.

In some implementations, the foregoing target time may be a period of time in the past. In this case, a terminal device located in the target area in target time may be understood as a terminal device located in the target area within a period of time in the past. In some other implementations, the foregoing target time may be a period of time in the future. In this case, a terminal device located in the target area in target time may be understood as a terminal device that is predicted to be located in the target area within a period of time in the future.

Screening condition 6: a terminal group used to obtain the candidate terminal device through screening. Correspondingly, a candidate terminal device obtained after screening belongs to the terminal group.

In some scenarios, to reduce a workload of obtaining the candidate terminal device through screening by the second core network element, the AF may limit a range of obtaining the candidate terminal device through screening by using the screening condition 6, that is, obtaining the candidate terminal device through screening in the terminal group.

The foregoing terminal group may include one or more terminal devices. In some implementations, the AF may determine the terminal group based on a terminal device used in a previous calculation process. Certainly, the AF may further determine the terminal group based on another factor, which is not limited in embodiments of this application.

The foregoing describes the screening conditions used in embodiments of this application with reference to the screening conditions 1 to 6. It should be noted that the foregoing screening conditions may be separately used to obtain the candidate terminal device through screening. Certainly, the foregoing screening conditions may also be mutually combined to obtain the candidate terminal device through screening.

In the following, a scenario of training an AI model is used as an example, and a solution of selecting a candidate terminal device according to an embodiment of this application is described with reference to FIG. 9 when the screening condition 1 and the screening condition 2 are combined.

Referring to FIG. 9, a target area 920 includes a coverage area 910 of an AF. Within the coverage area 910 of the AF, a terminal device may communicate with the AF, for example, participate in federated learning training. However, as described above, in a process of training an AI model, to ensure precision of the AI model, training data needs to be collected from the target area 920, to ensure diversity of the training data. Therefore, in a process of obtaining a candidate terminal device through screening, not only the coverage range 910 of the AF (that is, the screening condition 1) needs to be considered, but also whether a historical moving area of a terminal device partially or completely overlaps the target area 920 (that is, the screening condition 2) needs to be considered.

With reference to the foregoing screening condition 1 and the foregoing screening condition 2, a candidate terminal device obtained through screening may be a terminal device that is in the coverage range of the AF and has a historical moving area that at least partially overlaps the target area. Alternatively, the candidate terminal device is a terminal device that is currently located in the coverage range of the AF but visited the target area within a past time.

It should be noted that, to further improve precision of the AI model, in the process of selecting a candidate terminal device, terminal devices at different locations in the target area may be further selected as far as possible, to improve diversity of the training data.

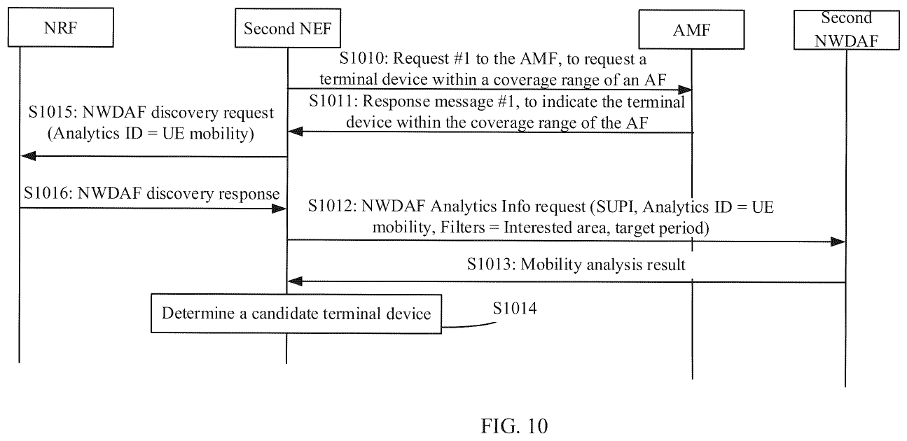

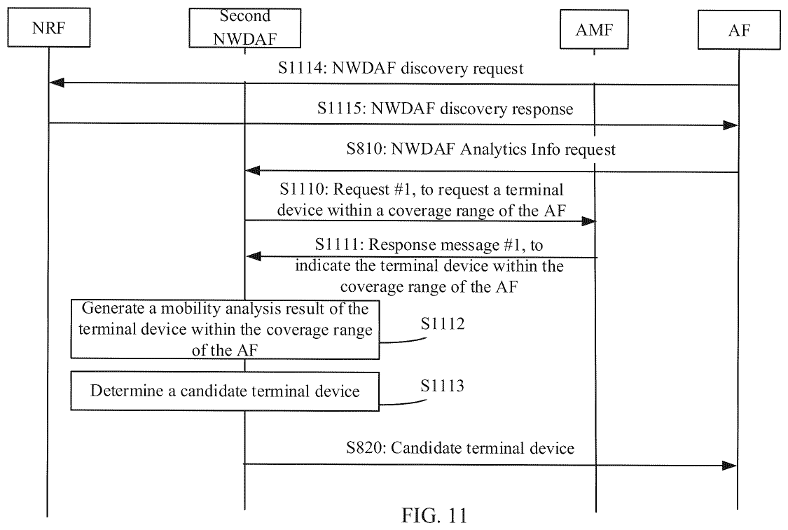

The foregoing describes screening conditions for obtaining a candidate terminal device through screening and the candidate terminal device with reference to FIG. 8 and FIG. 9. The following describes a solution for obtaining a candidate terminal device through screening by a second core network element. In an embodiment of this application, obtaining a candidate terminal device through screening may be executed by a second NEF or a second NWDAF, which is separately described in the following with reference to FIG. 10 and FIG. 11.

FIG. 10 is a flowchart of a method for obtaining a candidate terminal device through screening according to an embodiment of this application. The method shown in FIG. 10 includes step S1010 to step S1016.

Referring to FIG. 10, in a process in which a second NFE executes obtaining of a candidate terminal device through screening, the second NEF may interact with an AMF to obtain a terminal device within a coverage range of an AF.

That is, in step S1010, the second NEF transmits a request #1 to the AMF, to request the terminal device within the coverage range of the AF.

In step S1011, in response to the foregoing request #1, the AMF transmits a response message #1 to the second NEF, to indicate the terminal device within the coverage range of the AF.

In some implementations, the foregoing request #1 may be a subscription request. Correspondingly, the AMF transmits a plurality of response messages to the second NEF, to indicate the terminal device within the coverage range of the AF. In some other implementations, the foregoing plurality of response messages include a response message transmitted by the AMF to the second NEF each time the terminal device within the coverage range of the AF changes. In some other implementations, the foregoing plurality of response messages may be periodically transmitted by the AMF to the second NEF.

In step S1012, the second NEF may transmit, to a second NWDAF, a request #2 (also referred to as an analysis information request of a network data analysis function “NWDAF Analytics Info request”).

The request #2 is used to request a mobility analysis result of the terminal device within the coverage range of the AF.

The foregoing mobility analysis result of the terminal device is used to indicate a historical moving range and/or a predicted future moving range of the terminal device.

In some implementations, the foregoing transmitted request #2 may include one or more of the following information: an analysis identifier (represented by “Analytics ID”) of a network data analysis service #1; an identity of the terminal device within the coverage range of the AF; or an analysis condition (represented by “Filters”) of the network data analysis service #1.

The foregoing analysis identifier of the network data analysis service #1 is used to indicate that an analysis result of the network data analysis service #1 includes the mobility analysis result of the terminal device within the coverage range of the AF, and therefore may be represented as “Analytics ID=UE mobility”.

The foregoing identity of the terminal device within the coverage range of the AF is used to identify the terminal device within the coverage range of the AF. In some implementations, the foregoing identity may be a SUPI.

The foregoing analysis condition of the network data analysis service #1 may be used to indicate the foregoing screening conditions. For example, the analysis condition may include a target area (also referred to as an “interested area”) and a target period in the screening conditions, and therefore may be represented as “Filters=Interested area, target period”.

In step S1013, in response to the foregoing request #2, the second NWDAF transmits a response message #2 to the second NEF, to indicate the mobility analysis result (also referred to as “Mobility analytics result”) of the terminal device within the coverage range of the AF.

In step S1014, the second NEF determines the candidate terminal device based on the mobility analysis result of the terminal device within the coverage range of the AF.

It should be noted that in some scenarios, the second NEF may not learn of an NWDAF that can provide the mobility analysis result of the terminal device. Therefore, the second NEF may determine the second NWDAF by interacting with an NRF. That is, referring to FIG. 10, before step S1012, the foregoing method further includes step S1015 and step S1016.

In step S1015, the second NEF transmits, to the NRF, an NF discovery request #1 (also referred to as an “NWDAF discovery request”).

The NF discovery request #1 is used to request discovery of the NWDAF that can provide the mobility analysis result of the terminal device, and therefore may be represented as “NWDAF discovery request (Analytics ID=UE mobility)”.

In step S1016, the NRF transmits, to the second NEF, an NF discovery response #1 (also referred to as an “NWDAF discovery response”).

The foregoing NF discovery response is used to indicate that the second NWDAF may provide the mobility analysis result of the terminal device.

FIG. 11 is a flowchart of a method for obtaining a candidate terminal device through screening according to an embodiment of this application. The method shown in FIG. 11 includes step S1110 to step S1115.

Referring to FIG. 11, in a process in which a second NWDAF executes obtaining of a candidate terminal device through screening, the second NWDAF may interact with an AMF to obtain a terminal device within a coverage range of an AF.

That is, in step S1110, the second NWDAF transmits a request #1 to the AMF, to request the terminal device within the coverage range of the AF.

In step S1111, in response to the foregoing request #1, the AMF transmits a response message #1 to the second NWDAF, to indicate the terminal device within the coverage range of the AF.

In some implementations, the foregoing request #1 may be a subscription request. Correspondingly, the AMF transmits a plurality of response messages to the second NWDAF, to indicate the terminal device within the coverage range of the AF. In some other implementations, the foregoing plurality of response messages include a response message transmitted by the AMF to the second NWDAF each time the terminal device within the coverage range of the AF changes. In some other implementations, the foregoing plurality of response messages may be periodically transmitted by the AMF to the second NWDAF.

In step S1112, the second NWDAF may perform terminal device mobility analysis on the terminal device within the coverage range of the AF, to generate a mobility analysis result of the terminal device within the coverage range of the AF.

In step S1113, the second NWDAF determines the candidate terminal device based on the mobility analysis result of the terminal device within the coverage range of the AF.

It should be noted that in some scenarios, the AF may not learn of an NWDAF that can provide the mobility analysis result of the terminal device. Therefore, the AF may determine the second NWDAF by interacting with an NRF. That is, referring to FIG. 11, before step S1110, the foregoing method further includes step S1114 and step S1115.

In step S1114, the AF transmits, to the NRF, an NF discovery request #1 (also referred to as an “NWDAF discovery request”).

The NF discovery request #1 is used to request discovery of an NWDAF that may provide the mobility analysis result of the terminal device.

In step S1115, the NRF transmits, to the AF, an NF discovery response #1 (also referred to as an “NWDAF discovery response”).

The NF discovery response is used to indicate that the second NWDAF may provide the mobility analysis result of the terminal device.

As described above, the terminal device may interact with a core network element by using a DCAF, or may not interact with a core network element by using a DCAF. Communication manners supported by different terminal devices may vary. In this case, if a communication manner supported by a terminal device determined by the core network element is not the same as a communication manner actually supported by the terminal device, communication between the terminal device and the core network element may fail.

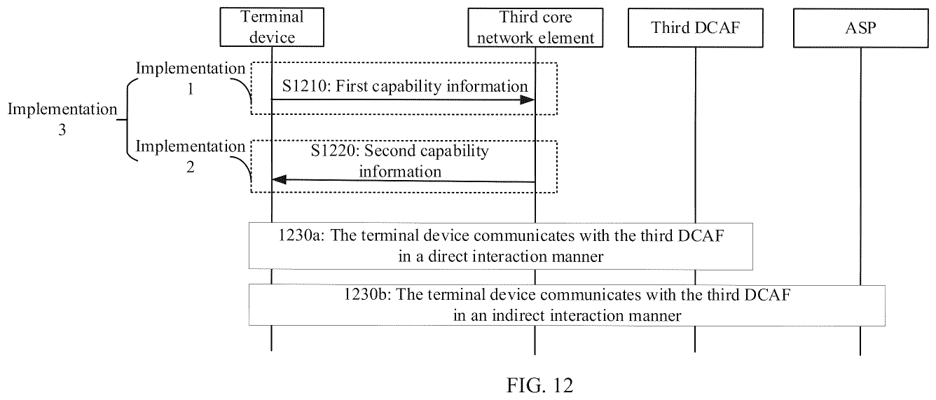

Therefore, to avoid the foregoing problem, this application further provides a wireless communication method, so that a terminal device may negotiate, with a core network element (also referred to as a third core network element), a manner of communication between the terminal device and the third core network element. The following describes a method according to an embodiment of this application with reference to FIG. 12. It should be noted that the method shown in FIG. 12 may be used in combination with any one of the foregoing methods. Certainly, the method shown in FIG. 12 may be used separately, which is not limited in embodiments of this application.

FIG. 12 is a schematic flowchart of a wireless communication method according to still yet another embodiment of this application. The method shown in FIG. 12 includes step S1210 and/or step S1220.

In step S1210, a terminal device transmits first capability information to a third core network element.

The first capability information is used to indicate whether the terminal device supports communication with the third core network element by using a third DCAF. Alternatively, the first capability information is used to indicate whether the terminal device expects to communicate with the third core network element by using the third DCAF. Alternatively, the first capability information is used to indicate whether the terminal device requests to communicate with the third core network element by using the third DCAF. Alternatively, the first capability information is used to indicate whether the terminal device is allowed to communicate with the third core network element by using the third DCAF.

The foregoing third core network element may be an AMF or an SMF. In addition, in some implementations, the foregoing first capability information may be transmitted by using a NAS message. If the third core network element is an AMF, the first capability information may be carried in a registration request message. If the third core network element is an SMF, the first capability information may be carried in a PDU session establishment request or a PDU session modification request. Certainly, in embodiments of this application, the foregoing first capability information may also be carried in a dedicated message, which is not limited in embodiments of this application.

It should be noted that the terminal device may determine the foregoing first capability information based on configuration of the terminal device. For example, the terminal device does not have a function of communicating with a DCAF. In this case, the terminal device may indicate, by using the first capability information, that the terminal device does not support communication with the third core network element by using the third DCAF. For another example, the terminal device has the function of communicating with a DCAF. In this case, the terminal device may indicate, by using the first capability information, that the terminal device supports communication with the third core network element by using the third DCAF.

In step S1220, the third core network element transmits second capability information to the terminal device.

The second capability information indicates whether the terminal device is allowed to communicate with the third core network element by using the third DCAF. Alternatively, the second capability information indicates whether the terminal device is agreed to communicate with the third core network element by using the third DCAF. Alternatively, the second capability information indicates whether the terminal device is supported to communicate with the third core network element by using the third DCAF.

The foregoing third core network element may be an AMF or an SMF. In addition, in some implementations, the foregoing second capability information may be transmitted by using a NAS message. If the third core network element is an AMF, the second capability information may be carried in a registration accept message. If the third core network element is an SMF, the second capability information may be carried in a PDU session establishment reply message or a PDU session modification reply message. Certainly, in embodiments of this application, the foregoing second capability information may also be carried in a dedicated message, which is not limited in embodiments of this application.

The method shown in FIG. 12 may be divided into the following three implementations.

In an implementation 1, the method shown in FIG. 12 may include only step S1210, but does not include step S1220. That is, after the terminal device transmits the first capability information to the third core network element, the third core network element may communicate with the terminal device based on an indication of the first capability information.

For example, the first capability information indicates that the terminal device supports communication with the third core network element by using the third DCAF. Correspondingly, the third core network element may communicate with the terminal device by using the third DCAF. For another example, the first capability information indicates that the terminal device does not support communication with the third core network element by using the third DCAF. Correspondingly, the third core network element may not communicate with the terminal device by using the third DCAF.

In an implementation 2, the method shown in FIG. 12 may include only step S1220, but does not include step S1210. That is, after the third core network element transmits the second capability information to the terminal device, the terminal device may communicate with the third core network element based on an indication of the second capability information.

For example, the second capability information indicates that the third core network element does not allow the terminal device to communicate with the third core network element by using the third DCAF. Correspondingly, the terminal device may not communicate with the third core network element by using the third DCAF. For another example, the second capability information indicates that the terminal device is allowed to communicate with the third core network element by using the third DCAF. Correspondingly, the terminal device may communicate with the third core network element by using the third DCAF.

In an implementation 3, the method in FIG. 12 includes step S1210 and step S1220. That is, the terminal device may notify the third core network element of a capability of the terminal device by using the first capability information. Correspondingly, the third core network element may determine a manner of communication with the terminal device based on the first capability information, and indicate the manner to the terminal device by using the second capability information. That is, the terminal device transmits the first capability information to the third core network element, where the first capability information is used to indicate whether the terminal device supports communication with the third core network element by using the third DCAF. In response to the first capability information, the third core network element transmits the second capability information to the terminal device, where the second capability information indicates whether the terminal device is allowed to communicate with the third core network element by using the third DCAF.

In some implementations, if the third core network element is an AMF, and the first capability information is carried in a registration request message, the second capability information may be carried in a registration accept message.

In some other implementations, if the third core network element is an SMF, and the first capability information is carried in a PDU session establishment request, correspondingly, the second capability information may be carried in a PDU session establishment reply message.

In some other implementations, if the third core network element is an SMF, and the first capability information is carried in a PDU session modification request, the second capability information may be carried in a PDU session modification reply message.

It should be noted that, that the foregoing first capability information is carried in a PDU session establishment request and the foregoing second capability information is carried in a PDU session establishment reply message may be understood as: The terminal device may interact with the third core network element based on a PDU session. Similarly, if the first capability information is carried in a PDU session modification request and the second capability information is carried in a PDU session modification reply message, it may also be understood as: The terminal device may interact with the third core network element based on a PDU session.

In some implementations, the foregoing first capability information includes one or more of the following information: indication information used to indicate whether the terminal device supports communication with the third core network element by using control plane signalling; indication information used to indicate whether the terminal device supports communication with the third core network element by using user plane signalling; indication information used to indicate whether the terminal device supports communication with the third DCAF in a direct interaction manner; or indication information used to indicate whether the terminal device supports communication with the third DCAF in an indirect interaction manner.

In some other implementations, the foregoing second capability information includes one or more of the following information: indication information used to indicate whether the terminal device is allowed to communicate with the third core network element by using control plane signalling; indication information used to indicate whether the terminal device is allowed to communicate with the third core network element by using user plane signalling; indication information used to indicate whether the terminal device is allowed to communicate with the third DCAF in a direct interaction manner; or indication information used to indicate whether the terminal device is allowed to communicate with the third DCAF in an indirect interaction manner.

The foregoing communication with the third core network element by using control plane signalling may be understood as: The communication between the terminal device and the third core network element may be implemented based on a transmission manner of control plane signalling in a core network architecture. In this case, information between the terminal device and the third core network element may be transmitted by using a NAS message.

The foregoing communication with the third core network element by using user plane signalling may be understood as: The communication between the terminal device and the third core network element may be implemented based on a transmission manner of a user plane signalling in a core network architecture. In this case, information between the terminal device and the third core network element may be forwarded by using a UPF network element. For example, the terminal device transmits a GTP-U message to the UPF by using an access network device. Correspondingly, the UPF transmits content in the GTP-U message to a control plane network element (for example, an NWDAF) of a core network instead of an application server in a data network. The same applies to transmission from the control plane network element of the core network to the terminal device.

As described above, in embodiments of this application, an NWDAF may provide a network data analysis service for a terminal device. Therefore, when transmitting the first capability information, the terminal device may notify the third core network element of a data analysis service requested by the terminal device (also referred to as “an analysis result of a second network data analysis service”). That is, the first capability information is carried in a fourth request, and the fourth request is used to request the analysis result of the second network data analysis service.

In some implementations, the terminal device may also directly carry an analysis identifier of the analysis result of the second network data analysis service in the fourth request.

It should be noted that the foregoing first capability information may also be transmitted separately from the fourth request, which is not limited in embodiments of this application.

As described above, in embodiments of this application, a core network element (for example, an AMF, a PCF, or an SMF) may provide a monitoring result of an event for a terminal device. Therefore, when transmitting the first capability information, the terminal device may notify the third core network element of a monitoring result of an event requested by the terminal device (also referred to as “a monitoring result of a second event”). That is, the first capability information is carried in the fourth request, and the fourth request is used to request the monitoring result of the second event.

In some implementations, the terminal device may also directly carry an identifier of the monitoring result of the second event in the fourth request.

It should be noted that the foregoing first capability information may also be transmitted separately from the fourth request, which is not limited in embodiments of this application.

As described above, in embodiments of this application, an NWDAF may provide a network data analysis service for a terminal device. Therefore, when transmitting the second capability information, the third core network element may notify the terminal device of a data analysis service allowed to be provided. That is, the third core network element transmits second indication information to the terminal device, where the second indication information is used to indicate an analysis result of the network data analysis service allowed to be provided for the terminal device. In some implementations, the second indication information may carry an analysis identifier of the analysis result of the network data analysis service allowed to be provided for the terminal device.

It should be noted that the foregoing second capability information may also be transmitted separately from the second indication information. Certainly, the foregoing second capability information and the second indication information may also be carried in a same message for transmission, which is not limited in embodiments of this application.

In addition, the foregoing analysis identifier of the analysis result of the network data analysis service allowed to be provided for the terminal device may be provided by an NWDAF that can provide the network data analysis service for the terminal device.

As described above, in embodiments of this application, a core network element (for example, an AMF, a PCF, or an SMF) may provide a monitoring result of an event for a terminal device. Therefore, when transmitting the second capability information, the third core network element may notify the terminal device of a monitoring result of an event that is allowed to be provided for the terminal device. That is, the third core network element transmits the second indication information to the terminal device, where the second indication information is used to indicate the monitoring result of the event that is allowed to be provided for the terminal device. In some implementations, the terminal device may also directly carry, in the second indication information, an identifier of the monitoring result of the event that is allowed to be provided for the terminal device.

It should be noted that the foregoing second capability information may also be transmitted separately from the second indication information. Certainly, the foregoing second capability information and the second indication information may also be carried in a same message for transmission, which is not limited in embodiments of this application.

In addition, the foregoing identifier of the monitoring result of the event that is allowed to be provided for the terminal device may be provided by a core network element that can provide the monitoring result of the event for the terminal device, where the core network element may be, for example, an AMF, a PCF, or an SMF.

If the terminal device may communicate with the third core network element by using the third DCAF, there are two communication manners between the terminal device and the third core network element based on the two communication manners between the terminal device and the third DCAF. It should be noted that the direct interaction manner and the indirect interaction manner have been described above. For brevity, details are not described in the following.

In a communication manner 1, referring to step S1230a in FIG. 12, the terminal device may communicate with the third DCAF in the direct interaction manner, and then the third DCAF communicates with the third core network element. In an implementation, the terminal device may directly transmit to-be-transmitted information to the third DCAF, and then the third DCAF transmits the information to the third core network element. In another implementation, the third core network element may transmit to-be-transmitted information to the third DCAF, and then the third DCAF directly transmits the to-be-transmitted information to the terminal device.

In a communication manner 2, referring to step S1230b in FIG. 12, the terminal device may communicate with the third DCAF in the indirect interaction manner, and then the third DCAF communicates with the third core network element. In an implementation, the terminal device may transmit to-be-transmitted information to an ASP, the ASP transmits the to-be-transmitted information to the third DCAF, and then the third DCAF transmits the information to the third core network element. In another implementation, the third core network element may transmit to-be-transmitted information to the third DCAF, the third DCAF transmits the to-be-transmitted information to an ASP, and then the ASP transmits the to-be-transmitted information to the terminal device.

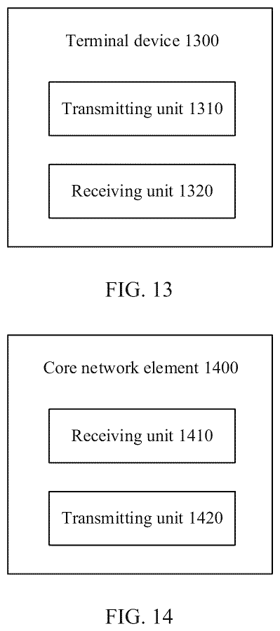

The foregoing describes method embodiments of this application in detail with reference to FIG. 1 to FIG. 12. The following describes apparatus embodiments of this application in detail with reference to FIG. 13 to FIG. 20. It should be understood that the description of the method embodiments corresponds to the description of the apparatus embodiments, and therefore, for parts that are not described in detail, refer to the foregoing method embodiments.

FIG. 13 is a schematic diagram of a terminal device according to an embodiment of this application. The terminal device 1300 shown in FIG. 13 includes a transmitting unit 1310 and a receiving unit 1320.

The transmitting unit 1310 is configured to transmit a first request, where the first request is used to request first information.

The receiving unit 1320 is configured to receive the first information transmitted by a first core network element, where the first information includes an analysis result of a first network data analysis service or a monitoring result of a first event.

In a possible implementation, if the first information includes the analysis result of the first network data analysis service, the first request carries one or more of the following information: a request type of the first request; a first identifier of the first network data analysis service; an analysis condition of the first network data analysis service; or an identity of the terminal device; or, if the first information includes the monitoring result of the first event, the first request carries one or more of the following information: a request type of the first request; an event trigger identifier of the first event; or an identity of the terminal device.

In a possible implementation, the transmitting unit is configured to transmit the first request to a first data collection application function (DCAF), where the first request is used by the first DCAF to generate a second request, and the second request is transmitted by the first DCAF to the first core network element.

In a possible implementation, if the first request carries the first identifier, and the first identifier is an external analysis identifier, a second identifier of the first network data analysis service that is carried in the second request is an internal analysis identifier.

In a possible implementation, the second identifier is converted by the first DCAF or a first network exposure function (NEF) based on the first identifier.

In a possible implementation, the transmitting unit is configured to transmit the first request to the first core network element by using a first DCAF.

In a possible implementation, the first request is transmitted by the terminal device to the first DCAF by using a first application service provider (ASP).

In a possible implementation, the receiving unit is configured to receive, by using the first DCAF, the first information transmitted by the first core network element.

In a possible implementation, the first information is transmitted by the first DCAF to the terminal device by using a second application service provider (ASP).

In a possible implementation, the terminal device communicates with the first DCAF by using an application connection of a user plane.

In a possible implementation, if the first request is a subscription request, the analysis result of the first network data analysis service includes a plurality of analysis results, or the monitoring result of the first event includes a plurality of monitoring results.

In a possible implementation, the monitoring result of the first event includes an event trigger notification of the first event.

In a possible implementation, if the first information includes the analysis result of the first network data analysis service, the first core network element is a first network data analysis function (NWDAF); or, if the first information includes the monitoring result of the first event, the first core network element is an AMF, a PCF, or an SMF.

FIG. 14 is a schematic diagram of a core network element according to an embodiment of this application. The core network element 1400 (also referred to as a first core network element) shown in FIG. 14 includes a receiving unit 1410 and a transmitting unit 1420.

The receiving unit 1410 is configured to receive a second request, where the second request is used by a terminal device to request first information.

The transmitting unit 1420 is configured to transmit the first information to the terminal device, where the first information includes an analysis result of a first network data analysis service or a monitoring result of a first event.

In a possible implementation, if the first information includes the analysis result of the first network data analysis service, the first request carries one or more of the following information: a request type of the first request; a first identifier of the first network data analysis service; an analysis condition of the first network data analysis service; or an identity of the terminal device; or, if the first information includes the monitoring result of the first event, the first request carries one or more of the following information: a request type of the first request; an event trigger identifier of the first event; or an identity of the terminal device.

In a possible implementation, the receiving unit is configured to receive the second request transmitted by a first data collection application function (DCAF), where the second request is generated by the first DCAF based on the first request, and the first request is transmitted by the terminal device.

In a possible implementation, if the first request carries the first identifier of the first network data analysis service, and the first identifier is an external analysis identifier, a second identifier carried in the second request is an internal analysis identifier.

In a possible implementation, the second identifier is converted by the first DCAF or a first network exposure function (NEF) based on the first identifier.

In a possible implementation, the receiving unit is configured to receive, by using a first DCAF, the first request transmitted by the terminal device, where the first request is the same as the second request.

In a possible implementation, the transmitting unit is configured to transmit the first information to the terminal device by using the first DCAF.

In a possible implementation, the first information is transmitted by the first DCAF to the terminal device by using a second application service provider (ASP).

In a possible implementation, the terminal device communicates with the first DCAF by using an application connection of a user plane.

In a possible implementation, if the first request is a subscription request, the analysis result of the first network data analysis service includes a plurality of analysis results, or the monitoring result of the first event includes a plurality of monitoring results.

In a possible implementation, if the first information includes the analysis result of the first network data analysis service, the first core network element is a first network data analysis function (NWDAF); or, if the first information includes the monitoring result of the first event, the first core network element is an AMF, a PCF, or an SMF.

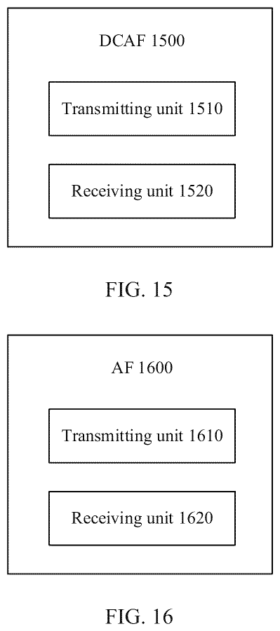

FIG. 15 is a schematic diagram of a DCAF according to an embodiment of this application. The DCAF 1500 shown in FIG. 15 is also referred to as a “first DCAF”, and includes a transmitting unit 1510 and a receiving unit 1520.

The transmitting unit 1510 is configured to transmit a second request to a first core network element, where the second request is used by a terminal device to request first information.

The receiving unit 1520 is configured to receive the first information transmitted by the first core network element.

The transmitting unit 1510 is configured to transmit the first information to the terminal device, where the first information includes an analysis result of a first network data analysis service or a monitoring result of a first event.

In a possible implementation, if the first information includes the analysis result of the first network data analysis service, the second request carries one or more of the following information: a request type of the second request; a second identifier of the first network data analysis service; an analysis condition of the first network data analysis service; or an identity of the terminal device; or, if the first information includes the monitoring result of the first event, the second request carries one or more of the following information: a request type of the second request; an event trigger identifier of the first event; or an identity of the terminal device.

In a possible implementation, the receiving unit is configured to receive a first request transmitted by the terminal device, where the first request is used to request the first information.

In a possible implementation, the receiving unit is configured to receive, by using a first application service provider (ASP), the first request transmitted by the terminal device.

In a possible implementation, the DCAF further includes a generation unit, configured to generate the second request based on the first request.

In a possible implementation, if the second request carries the second identifier of the first network data analysis service, and a first identifier of the first network data analysis service that is carried in the first request is an external analysis identifier, the second identifier is an internal analysis identifier of the first network data analysis service.

In a possible implementation, the second identifier is converted by the first DCAF or a first network exposure function (NEF) based on the first identifier.

In a possible implementation, the first request is the same as the second request.

In a possible implementation, the transmitting unit is configured to transmit the first information to the terminal device by using a second application service provider (ASP).

In a possible implementation, if the first request is a subscription request, the analysis result of the first network data analysis service includes a plurality of analysis results, or the monitoring result of the first event includes a plurality of monitoring results.

In a possible implementation, the terminal device communicates with the first DCAF by using an application connection of a user plane.

In a possible implementation, if the first information includes the analysis result of the first network data analysis service, the first core network element is a first network data analysis function (NWDAF); or, if the first information includes the monitoring result of the first event, the first core network element is an AMF, a PCF, or an SMF.

FIG. 16 is a schematic diagram of an AF according to an embodiment of this application. The AF 1600 shown in FIG. 16 includes a transmitting unit 1610 and a receiving unit 1620.

The transmitting unit 1610 is configured to transmit a third request, where the third request is used to request a candidate terminal device.

The receiving unit 1620 is configured to receive first indication information transmitted by a second core network element, where the first indication information is used to indicate the candidate terminal device.

In a possible implementation, the third request includes a screening condition used to obtain the candidate terminal device through screening, and the screening condition includes one or more of the following conditions: a terminal device located in a coverage range of the AF; a terminal device whose historical moving area at least partially overlaps a target area; a terminal device whose predicted future moving area at least partially overlaps the target area; a terminal device that stays in the target area for duration that is greater than or equal to target duration; or a terminal device located in the target area in target time.

In a possible implementation, the third request includes a terminal group used to obtain the candidate terminal device through screening.

In a possible implementation, the candidate terminal device is obtained through screening by a second network exposure function (NEF) and/or a second network data analysis function (NWDAF).

In a possible implementation, the second core network element is the second network exposure function (NEF) or the second network data analysis function (NWDAF).

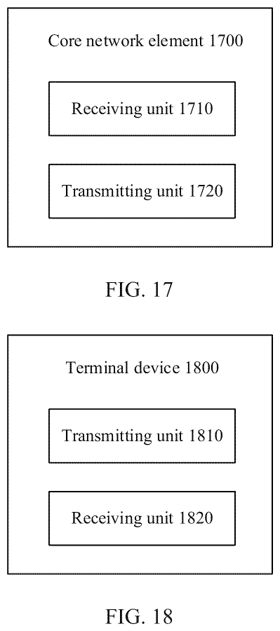

FIG. 17 is a schematic diagram of a core network element according to an embodiment of this application. The core network element 1700 shown in FIG. 17 is also referred to as a “second core network element”, and includes a receiving unit 1710 and a transmitting unit 1720.

The receiving unit 1710 is configured to receive a third request, where the third request is used by an application function (AF) to request a candidate terminal device.

The transmitting unit 1720 is configured to transmit first indication information to the AF, where the first indication information is used to indicate the candidate terminal device.

In a possible implementation, the third request includes a screening condition used to obtain the candidate terminal device through screening, and the screening condition includes one or more of the following conditions: a terminal device located in a coverage range of the AF; a terminal device whose historical moving area at least partially overlaps a target area; a terminal device whose predicted future moving area at least partially overlaps the target area; a terminal device that stays in the target area for duration that is greater than or equal to target duration; or a terminal device located in the target area in target time.

In a possible implementation, the third request includes a terminal group used to obtain the candidate terminal device through screening.

In a possible implementation, the candidate terminal device is obtained through screening by a second network exposure function (NEF) and/or a second network data analysis function (NWDAF).

In a possible implementation, the second core network element is the second network exposure function (NEF) or the second network data analysis function (NWDAF).

FIG. 18 is a schematic diagram of a terminal device according to an embodiment of this application. The terminal device 1800 shown in FIG. 18 includes a transmitting unit 1810 and a receiving unit 1820.

The transmitting unit 1810 is configured to transmit first capability information to a third core network element, where the first capability information is used to indicate whether the terminal device supports communication with the third core network element by using a third data collection application function (DCAF); and/or the receiving unit 1820 is configured to receive second capability information transmitted by the third core network element, where the second capability information indicates whether the terminal device is allowed to communicate with the third core network element by using the third DCAF.

In a possible implementation, the first capability information includes one or more of the following information: indication information used to indicate whether the terminal device supports communication with the third core network element by using control plane signalling; indication information used to indicate whether the terminal device supports communication with the third core network element by using user plane signalling; indication information used to indicate whether the terminal device supports communication with the third DCAF in a direct interaction manner; or indication information used to indicate whether the terminal device supports communication with the third DCAF in an indirect interaction manner.

In a possible implementation, the second capability information includes one or more of the following information: indication information used to indicate whether the terminal device is allowed to communicate with the third core network element by using control plane signalling; indication information used to indicate whether the terminal device is allowed to communicate with the third core network element by using user plane signalling; indication information used to indicate whether the terminal device is allowed to communicate with the third DCAF in a direct interaction manner; or indication information used to indicate whether the terminal device is allowed to communicate with the third DCAF in an indirect interaction manner.

In a possible implementation, the first capability information is carried in a fourth request, and the fourth request is used to request an analysis result of a second network data analysis service or a monitoring result of a second event.

In a possible implementation, the receiving unit is further configured to receive second indication information transmitted by the third core network element, where the second indication information is used to indicate an analysis result of a network data analysis service that is allowed to be provided for the terminal device, or the second indication information is used to indicate a monitoring result of an event that is allowed to be provided for the terminal device.

In a possible implementation, a NAS message carries the first capability information and/or the second capability information.

In a possible implementation, the third core network element includes an access and mobility management function (AMF) or a session management function (SMF).

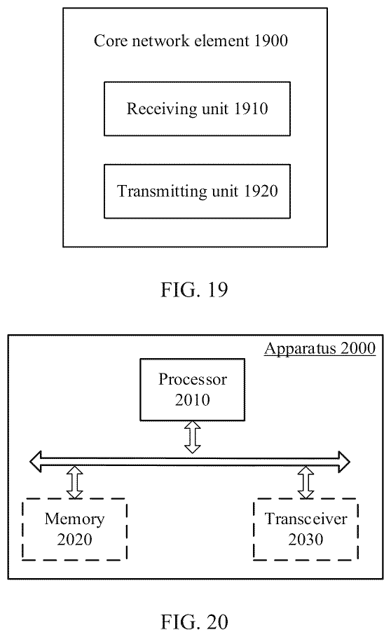

FIG. 19 is a schematic diagram of a core network element according to an embodiment of this application. The core network element 1900 shown in FIG. 19 is also referred to as a “third core network element”, and includes a receiving unit 1910 and a transmitting unit 1920.

The receiving unit 1910 is configured to receive first capability information transmitted by a terminal device, where the first capability information is used to indicate whether the terminal device supports communication with the third core network element by using a third DCAF; and/or the transmitting unit 1920 is configured to transmit second capability information to the terminal device, where the second capability information indicates whether the terminal device is allowed to communicate with the third core network element by using the third DCAF.

In a possible implementation, the first capability information includes one or more of the following information: indication information used to indicate whether the terminal device supports communication with the third core network element by using control plane signalling; indication information used to indicate whether the terminal device supports communication with the third core network element by using user plane signalling; an indication information used to indicate whether the terminal device supports communication with the third DCAF in a direct interaction manner; or indication information used to indicate whether the terminal device supports communication with the third DCAF in an indirect interaction manner.

In a possible implementation, the second capability information includes one or more of the following information: indication information used to indicate whether the terminal device is allowed to communicate with the third core network element by using control plane signalling; indication information used to indicate whether the terminal device is allowed to communicate with the third core network element by using user plane signalling; indication information used to indicate whether the terminal device is allowed to communicate with the third DCAF in a direct interaction manner; or indication information used to indicate whether the terminal device is allowed to communicate with the third DCAF in an indirect interaction manner.

In a possible implementation, the first capability information is carried in a fourth request, and the fourth request is used to request an analysis result of a second network data analysis service or a monitoring result of a second event.

In a possible implementation, the transmitting unit is further configured to transmit second indication information to the terminal device, where the second indication information is used to indicate an analysis result of a network data analysis service that is allowed to be provided for the terminal device, or the second indication information is used to indicate a monitoring result of an event that is allowed to be provided for the terminal device.

In a possible implementation, a NAS message carries the first capability information and/or the second capability information.

In a possible implementation, the third core network element includes an access and mobility management function (AMF) or a session management function (SMF).

FIG. 20 is a schematic structural diagram of a communications apparatus according to an embodiment of this application. The dashed lines in FIG. 20 indicate that the unit or module is optional. The apparatus 2000 may be configured to implement the methods described in the foregoing method embodiments. The apparatus 2000 may be a chip, a terminal device, or a network device.

The apparatus 2000 may include one or more processors 2010. The processor 2010 may allow the apparatus 2000 to implement the methods described in the foregoing method embodiments. The processor 2010 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 2000 may further include one or more memories 2020. The memory 2020 stores a program, where the program may be executed by the processor 2010, to cause the processor 2010 to execute the methods described in the foregoing method embodiments. The memory 2020 may be independent of the processor 2010 or may be integrated into the processor 2010.

The apparatus 2000 may further include a transceiver 2030. The processor 2010 may communicate with another device or chip by using the transceiver 2030. For example, the processor 2010 may transmit data to and receive data from another device or chip by using the transceiver 2030.

An embodiment of this application further provides a computer-readable storage medium, configured to store a program. The computer-readable storage medium may be applied to a terminal or a network device provided in embodiments of this application, and the program causes a computer to execute a method to be executed by the terminal or the network device in various embodiments of this application.

An embodiment of this application further provides a computer program product. The computer program product includes a program. The computer program product may be applied to a terminal or a network device provided in embodiments of this application, and the program causes a computer to execute a method to be executed by the terminal or the network device in various embodiments of this application.

An embodiment of this application further provides a computer program. The computer program may be applied to a terminal or a network device provided in embodiments of this application, and the computer program causes a computer to execute a method to be executed by the terminal or the network device in various embodiments of this application.

It should be understood that a name of each network element is not limited in embodiments of this application. The name of each network element may use the name described above, or may use another name of a network element that has a same function in a future communications system. In addition, a name of each piece of information is not limited in embodiments of this application. The name of each piece of information may be the name described above, and the name of each piece of information may also be another name of information that has a same function in a future communications system.

It should also be understood that, in embodiments of this application, “support” may be replaced with a word such as “expect”, “request”, or “allow”, indicating that a terminal device expects, requests, or allows an operation to be performed. In another embodiment of this application, “allow” may be replaced with a word such as “agree” or “support”, indicating that a core network element agrees or supports that a terminal device executes an operation.

The terms “system” and “network” in this application may be used interchangeably herein. In addition, the terms used in this application are only used to illustrate specific embodiments of this application, but are not intended to limit this application. The terms “first”, “second”, “third”, “fourth”, and the like in the specification, claims, and drawings of this application are used for distinguishing different objects from each other, rather than defining a specific order. In addition, the terms “include” and “have” and any variations thereof are intended to cover a non-exclusive inclusion.

In embodiments of this application, the “indication” mentioned may be a direct indication or an indirect indication, or indicate an association. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association between A and B.

In embodiments of this application, “B corresponding to A” means that B is associated with A, and B may be determined based on A. However, it should also be understood that, determining B based on A does not mean determining B based only on A, but instead B may be determined based on A and/or other information.

In embodiments of this application, the term “corresponding” may mean that there is a direct or indirect correspondence between two elements, or that there is an association relationship between two elements, or that there is a relationship of “indicating” and “being indicated”, “configuring” and “being configured”, or the like.

In embodiments of this application, “predefining” or “preconfiguring” may be implemented by prestoring corresponding code or a corresponding table in a device (for example, including a terminal device and a network device) or in other manners that may be used for indicating related information. A specific implementation thereof is not limited in this application. For example, predefining may indicate being defined in a protocol.

In embodiments of this application, the “protocol” may indicate a standard protocol in the communication field, which may include, for example, an LTE protocol, an NR protocol, and a related protocol applied to a future communications system. This is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, sequence numbers of the foregoing processes do not mean execution sequences. The execution sequences of the processes shall be determined based on functions and internal logic of the processes, and shall not constitute any limitation on the implementation processes of embodiments of this application.

In several embodiments provided in this application, it should be understood that, the disclosed systems, apparatuses, and methods may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between apparatuses or units may be implemented in electrical, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A wireless communication method, comprising:
transmitting, by a terminal device, a first request, wherein the first request is used to request first information; and
receiving, by the terminal device, the first information transmitted by a first core network element, wherein the first information comprises an analysis result of a first network data analysis service or a monitoring result of a first event.

2. The method according to claim 1, wherein if the first information comprises the analysis result of the first network data analysis service, the first request carries one or more of following information: a request type of the first request; a first identifier of the first network data analysis service; an analysis condition of the first network data analysis service; or an identity of the terminal device; or
if the first information comprises the monitoring result of the first event, the first request carries one or more of following information: a request type of the first request; an event trigger identifier of the first event; or an identity of the terminal device.

3. The method according to claim 2, wherein the transmitting, by a terminal device, a first request comprises:
transmitting, by the terminal device, the first request to a first data collection application function (DCAF), wherein the first request is used by the first DCAF to generate a second request, and the second request is transmitted by the first DCAF to the first core network element.

4. The method according to claim 2, wherein the transmitting, by a terminal device, a first request comprises:
transmitting, by the terminal device, the first request to the first core network element by using a first DCAF.

5. The method according to claim 3, wherein the receiving, by the terminal device, the first information transmitted by a first core network element comprises:
receiving, by the terminal device by using the first DCAF, the first information transmitted by the first core network element.

6. A terminal device, comprising a memory and a processor, wherein the memory is configured to store a program, and the processor is configured to invoke the program in the memory and run the computer program, to cause a wireless communication method, comprising:
transmitting, by a terminal device, a first request, wherein the first request is used to request first information; and
receiving, by the terminal device, the first information transmitted by a first core network element, wherein the first information comprises an analysis result of a first network data analysis service or a monitoring result of a first event.

7. The terminal device according to claim 6, wherein if the first information comprises the analysis result of the first network data analysis service, the first request carries one or more of following information: a request type of the first request; a first identifier of the first network data analysis service; an analysis condition of the first network data analysis service; or an identity of the terminal device; or
if the first information comprises the monitoring result of the first event, a first request carries one or more of following information: a request type of the first request; an event trigger identifier of the first event; or an identity of the terminal device.

8. The terminal device according to claim 7, wherein the transmitting, by a terminal device, a first request comprises:
transmitting, by the terminal device, the first request to a first data collection application function (DCAF), wherein the first request is used by the first DCAF to generate a second request, and the second request is transmitted by the first DCAF to the first core network element.

9. The terminal device according to claim 8, wherein if the first request carries the first identifier, and the first identifier is an external analysis identifier, a second identifier of the first network data analysis service that is carried in the second request is an internal analysis identifier.

10. The terminal device according to claim 9, wherein the second identifier is converted by the first DCAF or a first network exposure function (NEF) based on the first identifier.

11. The terminal device according to claim 7, wherein the transmitting, by a terminal device, a first request comprises:
transmitting, by the terminal device, the first request to the first core network element by using a first DCAF.

12. The terminal device according to claim 8, wherein the first request is transmitted by the terminal device to the first DCAF by using a first application service provider (ASP).

13. The terminal device according to claims 8, wherein the receiving, by the terminal device, the first information transmitted by a first core network element comprises:
receiving, by the terminal device by using the first DCAF, the first information transmitted by the first core network element.

14. The terminal device according to claim 13, wherein the first information is transmitted by the first DCAF to the terminal device by using a second application service provider (ASP).

15. The terminal device according to claim 8, wherein the terminal device communicates with the first DCAF by using an application connection of a user plane.

16. A first core network element, comprising a memory and a processor, wherein the memory is configured to store a program, and the processor is configured to invoke the program in the memory and run the computer program, to cause a wireless communication method, comprising:
receiving, by a first core network element, a second request, wherein the second request is used by a terminal device to request first information; and
transmitting, by the first core network element, the first information to the terminal device, wherein the first information comprises an analysis result of a first network data analysis service or a monitoring result of a first event.

17. The first core network element according to claim 16, wherein if the first information comprises the analysis result of the first network data analysis service, a first request carries one or more of following information: a request type of the first request; a first identifier of the first network data analysis service; an analysis condition of the first network data analysis service; or an identity of the terminal device; or
if the first information comprises the monitoring result of the first event, a first request carries one or more of following information: a request type of the first request; an event trigger identifier of the first event; or an identity of the terminal device.

18. The first core network element according to claim 17, wherein the receiving, by a first core network element, a second request comprises:
receiving, by the first core network element, the second request transmitted by a first data collection application function DCAF, wherein the second request is generated by the first DCAF based on the first request, and the first request is transmitted by the terminal device.

19. The first core network element according to claim 17, wherein the receiving, by a first core network element, a second request comprises:
receiving, by the first core network element by using a first DCAF, the first request transmitted by the terminal device, wherein the first request is the same as the second request.

20. The first core network element according to claims 18, wherein the transmitting by the first core network clement, the first information to the terminal device comprises:
transmitting, by the first core network element, the first information to the terminal device by using the first DCAF.
